(19) United States
(12) Patent Application Publication
(10) Pub. No.: US 2026/0035053 A1
(43) Pub. Date: Feb. 5, 2026

(54) SLIDE RAIL FOR SNOWMOBILE REAR SUSPENSION

(71) Applicant: BOMBARDIER RECREATIONAL PRODUCTS INC., Valcourt (CA)

(72) Inventors: Esa VAISANEN, Rovaniemi (FI); Mika KORSUMAKI, Rovaniemi (FI); Joonas MAHONEN, Rovaniemi (FI); Jesse KESKIAHO, Rovaniemi (FI)

(21) Appl. No.: 19/351,885

(22) Filed: Oct. 7, 2025

Related U.S. Application Data
(63) Continuation of application No. 18/934,969, filed on Nov. 1, 2024.
(60) Provisional application No. 63/595,936, filed on Nov. 3, 2023.

(51) Int. Cl. B62M 27/02; B60G 15/06

(52) U.S. Cl. CPC B62M 27/02; B60G 15/062; B62M 2027/026; B62M 2027/028

(57) ABSTRACT

A slide rail for a snowmobile rear suspension has an upturned front end portion; a middle portion rearward of the upturned front end portion, a bottom of the middle portion being flat; a rear end portion rearward of the middle portion, a bottom of the rear end portion being flat, the middle portion and the rear end portion comprising a bottom wall and a vertical wall connected to a top of the bottom wall, the bottom wall extending laterally outward from a left side of the vertical wall and laterally outward of a right side of the vertical wall to form an inverted T-shape; and a top wall connected to a top of the vertical wall, the top wall extending laterally from at least one of the left and right sides of the vertical wall.

### CROSS-REFERENCE

The present application is a continuation of U.S. patent application Ser. No. 18/934,969, filed Nov. 1, 2024, which claims priority from U.S. Provisional Patent Application 63/595,936, filed Nov. 3, 2023, the entirety of both of which is incorporated herein by reference.

### TECHNICAL FIELD

The present technology relates to slide rails for snowmobile rear suspensions.

### BACKGROUND

Snowmobiles typically have a frame having a tunnel, one or two front skis connected to a front of the frame via one or two front suspensions, a rear suspension connected to the tunnel, an endless track provided around the rear suspension, and a motor operatively connected to the endless track to drive the endless track.

An important characteristic of a snowmobile rear suspension is its travel. The travel is the amount by which the snowmobile rear suspension can be compressed. This can be limited by the need to restrict the movement of components of the snowmobile rear suspension to prevent components from having undesirable collisions with each other.

There is therefore a desire for a snowmobile rear suspension which addresses the issue of limited travel due to interference between its components.

Many snowmobile rear suspensions have a set geometry. As such their operational characteristics remain the same. However, these operational characteristics may not be suitable to all riding surfaces (i.e., ice, soft snow, groomed trails, hills . . . ) and/or for all driving styles.

There is therefore a desire for a snowmobile rear suspension which provides some adjustments.

Also, it is desirable for a snowmobile rear suspension to compress and decompress in order to absorb bumps. However, in some cases a construction of a snowmobile rear suspension that is optimized for this may result in a snowmobile rear suspension that twists about a longitudinal axis. This could have an effect on how the endless track follows the snowmobile rear suspension.

There is therefore a desire for a construction of a snowmobile rear suspension that addresses the above-mentioned twisting.

Snowmobile rear suspensions have many different parts, which can increase the cost and complexity of assembly of the rear suspensions.

There is therefore a desire for a snowmobile rear suspension with a reduced number of parts.

### SUMMARY

It is an object of the present technology to ameliorate at least some of the inconveniences present in the prior art.

According to one aspect of the present technology, there is provided a snowmobile rear suspension having: a left slide rail; a right slide rail; a front suspension arm assembly pivotally connected to the left slide rail and the right slide rail; and a rear suspension arm assembly pivotally connected to the left slide rail and the right slide rail. The rear suspension arm assembly has: a left arm; a first lower left finger connected to a lower end of the left arm; a second lower left finger connected to the lower end of the left arm, the left slide rail being received laterally between the first lower left finger and the second lower left finger, the first lower left finger and the second lower left finger being pivotally connected to the left slide rail; and a right arm; a first lower right finger connected to a lower end of the right arm; and a second lower right finger connected to the lower end of the right arm, the right slide rail being received laterally between the first lower right finger and the second lower right finger, the first lower right finger and the second lower right finger being pivotally connected to the right slide rail.

In some embodiments, the rear suspension arm assembly also has: a rear left fastener extending through the first lower left finger, the left slide rail and the second lower left finger; and a rear right fastener extending through the first lower right finger, the right slide rail and the second lower right finger.

In some embodiments, the left slide rail defines a rear left slot; the right slide rail defines a rear right slot; and the rear suspension arm assembly also has: a left sleeve disposed in the rear left slot and laterally between the first lower left finger and the second lower left finger, the rear left fastener extending through the left sleeve, the left sleeve moving within the rear left slot; and a right sleeve disposed in the rear right slot and laterally between the first lower right finger and the second lower right finger, the rear right fastener extending through the right sleeve, the right sleeve moving within the rear right slot.

In some embodiments, the rear left slot is a linear slot; the rear right slot is a linear slot; the left sleeve is a slider block; and the right sleeve is a slider block.

In some embodiments, the rear left slot is an arcuate slot; the rear right slot is an arcuate slot; the left sleeve is a roller; and the right sleeve is a roller.

In some embodiments, the rear suspension arm assembly also has a cross-member connected to and extending laterally between the left arm and the right arm.

In some embodiments, the rear suspension arm assembly also has: an axle connected to and extending laterally between the left arm and the right arm, the cross-member being disposed between the axle and the lower ends of the left and right arms; and at least one idler wheel mounted to the axle.

In some embodiments, the rear suspension arm assembly also has: an axle connected to and extending laterally between the left arm and the right arm; and at least one idler wheel mounted to the axle.

In some embodiments, the axle is disposed between the lower ends of the left and right arms and upper ends of the left and right arms.

In some embodiments, the rear suspension arm assembly also has: a first upper left finger connected to an upper end of the left arm; a second upper left finger connected to the upper end of the left arm, the first upper left finger and the second upper left finger being configured to receive a left side of a tunnel of a snowmobile therebetween and to pivotally connect to the left side of the tunnel; a first upper right finger connected to an upper end of the right arm; and a second upper right finger connected to the upper end of the right arm, the first upper right finger and the second upper right finger being configured to receive a right side of the tunnel therebetween and to pivotally connect to the right side of the tunnel.

In some embodiments, a rear shock absorber is connected between the rear suspension arm assembly and the left and right slide rails.

In some embodiments, a coil spring is operatively connected to the rear shock absorber. The rear shock absorber extends inside the coil spring.

In some embodiments, a front shock absorber is connected between the front suspension arm assembly and the left and right slide rails.

In some embodiments, a rear axle is connected to and extends laterally between a rear end of the left slide rail and a rear end of the right slide rail; and at least one rear idler wheel is mounted to the rear axle.

According to another aspect of the present technology, there is provided a snowmobile having: a frame, the frame having a tunnel; at least one ski operatively connected to the frame; the above snowmobile rear suspension operatively connected to the tunnel; an endless track provided around the snowmobile rear suspension; and a motor operatively connected to the endless track for driving the endless track.

According to another aspect of the present technology, there is provided a snowmobile rear suspension having: a left slide rail; a right slide rail; a front suspension arm assembly pivotally connected to the left slide rail and the right slide rail; a rear suspension arm assembly pivotally connected to the left slide rail and the right slide rail; and a rear shock absorber connected between the rear suspension arm assembly and the left and right slide rails, the rear shock absorber having an upper end pivotally connected to the rear suspension arm assembly about a first laterally extending axis such that a connection between the upper end of the rear shock absorber and the rear suspension arm assembly provides a single degree of freedom, the rear shock absorber having a lower end pivotally connected to the left and right slide rails about a second laterally extending axis such that a connection between the lower end of the rear shock absorber and the left and right slide rails provides a single degree of freedom.

In some embodiments, a rear coil spring is operatively connected to the rear shock absorber. The rear shock absorber extends inside the rear coil spring.

In some embodiments, the second laterally extending axis extends through the left slide rail and the right slide rail.

In some embodiments, a front shock absorber is connected between the front suspension arm assembly and the left and right slide rails.

In some embodiments, a front coil spring is operatively connected to the front shock absorber. The front shock absorber extends inside the front coil spring.

In some embodiments, a bracket is connected to and extending between the left slide rail and the right slide rail. The lower end of the rear shock absorber is pivotally connected to the bracket. A lower end of the front shock absorber is pivotally connected to the bracket.

In some embodiments, the bracket is a H-shaped bracket having: a front arm extending laterally between the left slide rail and the right slide rail; a rear arm extending laterally between the left slide rail and the right slide rail; and a longitudinal arm extending longitudinally between the front arm and the rear arm. The lower end of the front shock absorber is pivotally connected to the front arm of the bracket. The lower end of the rear shock absorber is pivotally connected to the rear arm of the bracket.

In some embodiments, the rear suspension arm assembly has: an axle connected to and extending laterally between the left arm and the right arm; and at least one idler wheel mounted to the axle.

In some embodiments, the axle defines an axle axis; and the axle axis is vertically between the first laterally extending axis and the second laterally extending axis.

In some embodiments, the at least one idler wheel is two idler wheels; and the upper end of the rear shock absorber is pivotally connected to the axle at a position laterally between the two idler wheels.

In some embodiments, the first laterally extending axis extends through the two idler wheels.

In some embodiments, the rear suspension arm assembly also has: a left arm pivotally connected to the left slide rail; a right arm pivotally connected to the right slide rail; a cross-member connected to and extending laterally between the left arm and the right arm; and a bracket connected between the cross-member and the axle. The upper end of the rear shock absorber is pivotally connected to the bracket.

In some embodiments, the rear suspension arm assembly has: a left arm pivotally connected to the left slide rail; a right arm pivotally connected to the right slide rail; and a cross-member connected to and extending laterally between the left arm and the right arm. The upper end of the rear shock absorber is pivotally connected to the cross-member.

In some embodiments, the rear suspension arm assembly also has a bracket connected to the cross-member. The upper end of the rear shock absorber is pivotally connected to the bracket.

In some embodiments, the cross-member is vertically between the first laterally extending axis and the second laterally extending axis.

In another aspect of the present technology, there is provided a snowmobile having: a frame, the frame having a tunnel; at least one ski operatively connected to the frame; the above snowmobile rear suspension operatively connected to the tunnel; an endless track provided around the snowmobile rear suspension; and a motor operatively connected to the endless track for driving the endless track.

According to another aspect of the present technology, there is provided a snowmobile rear suspension having: a left slide rail defining: a rear left tensioner slot, and a rear left tensioner aperture in a rear end of the left slide rail and extending longitudinally from the rear end of the left slide rail to the rear left tensioner slot; a right slide rail defining: a rear right tensioner slot, and a rear right tensioner aperture in a rear end of the right slide rail and extending longitudinally from the rear end of the right slide rail to the rear right tensioner slot; a front suspension arm assembly pivotally connected to the left slide rail and the right slide rail; a rear suspension arm assembly pivotally connected to the left slide rail and the right slide rail; a rear axle connected to and extending laterally between the left slide rail and the right slide rail; at least one rear idler wheel mounted to the rear axle; a left tensioner fastener extending through the rear left tensioner aperture and into the rear left tensioner slot, the left tensioner fastener being fastened to a left end of the rear axle, rotation of the left tensioner fastener adjusting a distance between the left end of the rear axle and the rear end of the left slide rail; and a right tensioner fastener extending through the rear right tensioner aperture and into the rear right tensioner slot, the right tensioner fastener being fastened to a right end of the rear axle, rotation of the right tensioner fastener adjusting a distance between the right end of the rear axle and the rear end of the right slide rail.

In some embodiments, the rear left tensioner aperture and the rear right tensioner aperture are threadless.

In some embodiments, the rear left tensioner aperture is laterally centered in the rear end of the left slide rail; and the rear right tensioner aperture is laterally centered in the rear end of the right slide rail.

In some embodiments, the rear left tensioner aperture is vertically centered in the rear left tensioner slot; and the rear right tensioner aperture is vertically centered in the rear right tensioner slot.

In some embodiments, the left end of the rear axle extends in the rear left tensioner slot; and the right end of the rear axle extends in the rear right tensioner slot.

In some embodiments, a left fastener is connected to the left end of the rear axle, the left fastener abutting a left side of the left slide rail; and a right fastener is connected to the right end of the rear axle, the right fastener abutting a right side of the right slide rail.

In some embodiments, the at least one rear idler wheel is two rear idler wheels.

In some embodiments, a tube is disposed laterally between and connected to the two rear idler wheels. The axle extends through the tube.

In some embodiments, a rear shock absorber is connected between the rear suspension arm assembly and the left and right slide rails.

In some embodiments, a rear coil spring is operatively connected to the rear shock absorber. The rear shock absorber extends inside the rear coil spring.

In some embodiments, a front shock absorber is connected between the front suspension arm assembly and the left and right slide rails.

In some embodiments, a front coil spring is operatively connected to the front shock absorber. The front shock absorber extends inside the front coil spring.

According to another aspect of the present technology, there is provide a snowmobile having: a frame, the frame having a tunnel; at least one ski operatively connected to the frame; the above snowmobile rear suspension operatively connected to the tunnel; an endless track provided around the snowmobile rear suspension; and a motor operatively connected to the endless track for driving the endless track.

In some embodiments, the endless track biases the at least one rear idler wheel toward a front of the snowmobile such that: a head of the left tensioner fastener abuts the rear end of the left slide rail; and a head of the right tensioner fastener abuts the rear end of the right slide rail.

According to another aspect of the present technology, there is provided a slide rail for a snowmobile rear suspension having: an upturned front end portion; and a rear end portion defining: a rear tensioner slot, the rear tensioner slot being configured to support a rear axle of the snowmobile rear suspension; and a rear tensioner aperture in a rear end of the slide rail and extending longitudinally from the rear end of the slide rail to the left tensioner slot, the rear tensioner aperture being configure to receive a tensioner fastener extending through the rear tensioner aperture and into the rear tensioner slot, the tensioner fastener being configured to fasten to an end of the rear axle such that rotation of the tensioner fastener adjusts a distance between the end of the rear axle and the rear end of the slide rail.

In some embodiments, the left tensioner aperture is threadless.

In some embodiments, the rear tensioner aperture is laterally centered in the rear end of the slide rail.

In some embodiments, the rear tensioner aperture is vertically centered in the rear tensioner slot.

According to another aspect of the present technology, there is provided a snowmobile rear suspension having: a left slide rail; a right slide rail; a front suspension arm assembly pivotally connected to the left slide rail and the right slide rail; and a rear suspension arm assembly pivotally connected to the left slide rail and the right slide rail. The rear suspension arm assembly has: an upper end configured to be pivotally connected to a tunnel of a snowmobile about a first laterally extending axis, and a lower end pivotally connected to the left and right slide rails about a second laterally extending axis. A rear shock absorber is connected between the rear suspension arm assembly and the left and right slide rails. The rear shock absorber has: an upper end pivotally connected to the rear suspension arm assembly about a third laterally extending axis, and a lower end pivotally connected to the left and right slide rails about a fourth laterally extending axis. The snowmobile rear suspension is movable between a decompressed configuration and a compressed configuration. In the decompressed configuration, a central axis of the rear shock absorber passing under the first laterally extending axis. In the compressed configuration, the central axis of the rear shock absorber passing over the first laterally extending axis.

In some embodiments, in the decompressed configuration, the third laterally extending axis is vertically lower than the first laterally extending axis; and in the compressed configuration, the third laterally extending axis is vertically higher than the first laterally extending axis.

In some embodiments, the second and fourth laterally extending axes extend through the left and right slide rails.

In some embodiments, in the decompressed configuration and in the compressed configuration, the first and third laterally extending axes are vertically higher than the second and fourth laterally extending axes.

In some embodiments, in the decompressed configuration: the central axis is at a first angle to a first plane containing the second and fourth laterally extending axes, and a second plane is at a second angle to the first plane, the second plane passing through the first and second laterally extending axes. In the compressed configuration: the central axis is at a third angle to the first plane, the third angle being smaller than the first angle, and the second plane is at fourth angle to the first plane, the fourth angle being smaller than the second angle.

In some embodiments, the first angle is smaller than the second angle.

In some embodiments, the third angle is greater than the fourth angle.

In some embodiments, the rear suspension arm assembly has: a left arm pivotally connected to the left slide rail; a right arm pivotally connected to the right slide rail; and a cross-member connected to and extending laterally between the left arm and the right arm.

In some embodiments, the rear suspension arm assembly also has: an axle connected to and extending laterally between the left arm and the right arm, the cross-member being disposed between the axle and the lower ends of the left and right arms; and at least one idler wheel mounted to the axle.

In some embodiments, the rear suspension arm assembly has: a left arm pivotally connected to the left slide rail; a right arm pivotally connected to the right slide rail; an axle connected to and extending laterally between the left arm and the right arm; and at least one idler wheel mounted to the axle.

In some embodiments, the axle is disposed between lower ends of the left and right arms and upper ends of the left and right arms.

In some embodiments, the at least one idler wheel is two idler wheels; and the upper end of the rear shock absorber is pivotally connected to the axle at a position laterally between the two idler wheels.

In some embodiments, the third laterally extending axis extends through the two idler wheels.

In some embodiments, a rear coil spring operatively is connected to the rear shock absorber. The rear shock absorber extends inside the rear coil spring.

In some embodiments, a front shock absorber is connected between the front suspension arm assembly and the left and right slide rails.

In some embodiments, a front coil spring is operatively connected to the front shock absorber. The front shock absorber extends inside the front coil spring.

According to another aspect of the present technology, there is provided a snowmobile having: a frame, the frame having a tunnel; at least one ski operatively connected to the frame; the above snowmobile rear operatively connected to the tunnel; an endless track provided around the snowmobile rear suspension; and a motor operatively connected to the endless track for driving the endless track.

According to another aspect of the present technology, there is provided a snowmobile rear suspension having: a left slide rail; a right slide rail; a front suspension arm assembly pivotally connected to the left slide rail and the right slide rail; a rear suspension arm assembly pivotally connected to the left slide rail and the right slide rail; a front left stopper strap having an upper end connected to the front suspension arm assembly and a lower end connected to a front portion of the left slide rail, a side of the lower end of the front left stopper strap abutting a left rough surface; and a front right stopper strap having an upper end connected to the front suspension arm assembly and a lower end connected to a front portion of the right slide rail, a side of the lower end of the front right stopper strap abutting a right rough surface.

In some embodiments, the left rough surface is provided on a left side of the front portion of the left slide rail; and the right rough surface is provided on a right side of the front portion of the right slide rail.

In some embodiments, the left rough surface is integrally formed with the front portion of the left slide rail; and the right rough surface is integrally formed with the front portion of the right slide rail.

In some embodiments, the left rough surface is a left toothed surface; and the right rough surface is a right toother surface.

In some embodiments, the left toothed surface has a plurality of longitudinally extending left teeth arranged in a vertical stack; and the right toothed surface has a plurality of longitudinally extending right teeth arranged in a vertical stack.

In some embodiments, the left rough surface defines at least one left surface aperture; the front left stopper strap defines at least one lower left strap aperture; the right rough surface defines at least one right surface aperture; and the front right stopper strap defines at least one lower right strap aperture. The snowmobile rear suspension also has: a left fastener extending through one of the at least one lower left strap aperture and one of the at least one left surface aperture, the left fastener fastening the lower end of the front left stopper strap to the front portion of the left slide rail; and a right fastener extending through one of the at least one lower right strap aperture and one of the at least one right surface aperture, the right fastener fastening the lower end of the front right stopper strap to the front portion of the right slide rail.

In some embodiments, the at least one left surface aperture is a plurality of left surface apertures, the left surface apertures of the plurality of left surface apertures being defined at different vertical positions in the left rough surface; and the at least one right surface aperture is a plurality of right surface apertures, the right surface apertures of the plurality of right surface apertures being defined at different vertical positions in the right rough surface.

In some embodiments, the plurality of left surface apertures is three left surface apertures disposed in line; and the plurality of right surface apertures is three right surface apertures disposed in line.

In some embodiments, the at least one lower left strap aperture is a single lower left strap aperture; and the at least one lower right strap aperture is a single lower right strap aperture.

In some embodiments, the snowmobile rear suspension also has: a left washer; and a right washer. The left fastener extends through the left washer; the left washer is disposed between a head of the left fastener and the lower end of the front left stopper strap; the lower end of the front left stopper strap is disposed between the left washer and the left rough surface; the right fastener extends through the right washer; the right washer is disposed between a head of the right fastener and the lower end of the front right stopper strap; and the lower end of the front right stopper strap is disposed between the right washer and the right rough surface.

In some embodiments, the front suspension arm assembly has: a left arm pivotally connected to the left slide rail; and a right arm pivotally connected to the right slide rail. The upper end of the front left stopper strap is connected to the left arm. The upper end of the front right stopper strap is connected to the right arm.

In some embodiments, the upper end of the front left stopper strap is looped around the left arm; and the upper end of the front right stopper strap is looped around the right arm.

In some embodiments, the upper end of the front left stopper strap has a first portion overlapping a second portion to form a left loop through which the left arm extends; and the upper end of the front right stopper strap has a first portion overlapping a second portion to form a right loop through which the right arm extends. The snowmobile rear suspension also has: an upper left fastener fastening the first and second portions of the upper end of the front left stopper strap together; and an upper right fastener fastening the first and second portions of the upper end of the front right stopper strap together.

In some embodiments, the first portion of the upper end of the front left stopper strap defines a plurality of first apertures; the second portion of the upper end of the front left stopper strap defines at least one second aperture; the upper left fastener extends through one first aperture of the plurality of first apertures and through one of the at least one second aperture; the first portion of the upper end of the front right stopper strap defines a plurality of third apertures; the second portion of the upper end of the front right stopper strap defines at least one fourth aperture; and the upper right fastener extends through one third aperture of the plurality of third apertures and through one of the at least one fourth aperture.

In some embodiments, the front suspension arm assembly also has a cross-member connected to and extending laterally between the left arm and the right arm. The snowmobile rear suspension also has a front shock absorber connected between the cross-member and the left and right slide rails.

In some embodiments, a front shock absorber is connected between the front suspension arm assembly and the left and right slide rails.

In some embodiments, a front coil spring is operatively connected to the front shock absorber. The front shock absorber extends inside the front coil spring.

According to another aspect of the present technology, there is provided a snowmobile having: a frame, the frame having a tunnel; at least one ski operatively connected to the frame; the above snowmobile rear suspension operatively connected to the tunnel; an endless track provided around the snowmobile rear suspension; and a motor operatively connected to the endless track for driving the endless track.

According to another aspect of the present technology, there is provided a slide rail for a snowmobile rear suspension having: an upturned front end portion defining a rough surface of a lateral side thereof, the rough surface defining at least one surface aperture for fastening a lower end of a front stopper strap of the snowmobile rear suspension; and a rear end portion.

In some embodiments, the rough surface is a toothed surface.

In some embodiments, the toothed surface has a plurality of longitudinally extending teeth arranged in a vertical stack.

In some embodiments, the at least one surface aperture is a plurality of surface apertures. The surface apertures of the plurality of surface apertures are defined at different vertical positions in the rough surface.

In some embodiments, the plurality of surface apertures is three surface apertures disposed in line.

According to another aspect of the present technology, there is provided a slide rail for a snowmobile rear suspension having: an upturned front end portion; a middle portion rearward of the upturned front end portion, a bottom of the middle portion being flat; and a rear end portion rearward of the middle portion, a bottom of the rear end portion being flat. The middle portion and the rear end portion have a bottom wall and a vertical wall connected to a top of the bottom wall. The bottom wall extends laterally outward from a left side of the vertical wall and laterally outward of a right side of the vertical wall to form an inverted T-shape.

In some embodiments, the bottom wall extends along a majority of a length of the middle portion and the rear end portion.

In some embodiments, the bottom wall extends along an entire length of the middle portion and the rear end portion.

In some embodiments, a top wall is connected to a top of the vertical wall. The top wall extends laterally outward from only one of the left and right sides of the vertical wall to form an inverted L-shape.

In some embodiments, the top wall is connected to the vertical wall along the front end portion, the middle portion, and the rear end portion.

In some embodiments, the vertical wall defines a plurality of wall apertures.

In some embodiments, a surface area of the plurality of wall apertures is greater than a surface area of the vertical wall.

In some embodiments, the front end portion defines an aperture for receiving a fastener for fastening a slider shoe to the slide rail; and the bottom wall is configured from being received in slots defined in the slider shoe.

According to another aspect of the present technology, there is provided a snowmobile rear suspension having: a left slide rail according to the above; a right slide rail according to the above; a front suspension arm assembly pivotally connected to the left slide rail and the right slide rail; a rear suspension arm assembly pivotally connected to the left slide rail and the right slide rail; and a shock absorber pivotally connected to one of the front and rear suspension arm assemblies and pivotally connected to the left and right slide rails.

According to another aspect of the present technology, there is provided a snowmobile having: a frame, the frame having a tunnel; at least one ski operatively connected to the frame; the above snowmobile rear suspension operatively connected to the tunnel; an endless track provided around the snowmobile rear suspension; and a motor operatively connected to the endless track for driving the endless track.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a snowmobile;

FIG. 2 is a perspective view, taken from a rear, left side, of a rear suspension of the snowmobile of FIG. 1, with the rear suspension being in a decompressed configuration;

FIG. 3 is a top plan view of the rear suspension of FIG. 2;

FIG. 4 is a rear elevation view of rear suspension of FIG. 2;

FIG. 5 is a left side elevation view of the rear suspension of FIG. 2;

FIG. 6 is a left side elevation view of the rear suspension of FIG. 2, with the rear suspension being in a compressed configuration;

FIG. 7 is a left side elevation view of the rear suspension of FIG. 2, with an upper left idler wheel being removed;

FIG. 8 is a perspective view, taken from a rear, left side, of a cross-section of the rear suspension of FIG. 2 taken through line 8-8 of FIG. 3;

FIG. 9 is a cross-sectional view of the rear suspension of FIG. 2 taken through line 9-9 of FIG. 5;

FIG. 10 is a perspective view, taken from a rear, left side, of a rear suspension arm assembly of the rear suspension of FIG. 2;

FIG. 11 is a top plan view of the rear suspension arm assembly of FIG. 10;

FIG. 12 is a left side elevation view of the rear suspension assembly of FIG. 10;

FIG. 13 is a perspective view, taken from a rear, left side, of a close-up, exploded view of a connection between an upper left end of a rear suspension arm of the rear suspension of FIG. 2 to a tunnel of the snowmobile of FIG. 1;

FIG. 14 is a cross-sectional view of the snowmobile of FIG. 1 taken through line 14-14 of FIG. 1 showing the connection between the upper left end of the rear suspension arm and the tunnel;

FIG. 15 is a perspective view, taken from a front, right side, of a front portion of the rear suspension of FIG. 2, with a front right stopper strap being disconnected from a right slide rail;

FIG. 16 is a perspective view, taken from a rear, left side, of a left slide rail of the rear suspension assembly of FIG. 2;

FIG. 17 is a left side view of the left slide rail of FIG. 16;

FIG. 18 is a top plan view of the left slide rail of FIG. 16;

FIG. 19 is a cross-sectional view of the left slide rail of FIG. 16 taken through line 19-19 of FIG. 17;

FIG. 20 is a perspective view, taken from a rear, left side of a rear portion of the rear suspension of FIG. 2;

FIG. 21 is a perspective view, taken from a rear, left side of the rear portion of the rear suspension of FIG. 20, with a track tensioner of the rear suspension being in a position providing less tension on a track of the snowmobile of FIG. 1 than a position of the track tensioner in FIG. 20;

FIG. 22 is a cross-sectional view of the rear suspension of FIG. 2 taken through line 22-22 of FIG. 3;

FIG. 23 is a left side elevation view of the rear portion of the rear suspension of FIG. 20;

FIG. 24 is a left side elevation view of a rear portion of an alternative embodiment of the rear suspension of FIG. 2; and

FIG. 25 is a left side elevation view of a rear portion of another alternative embodiment of the rear suspension of FIG. 2.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

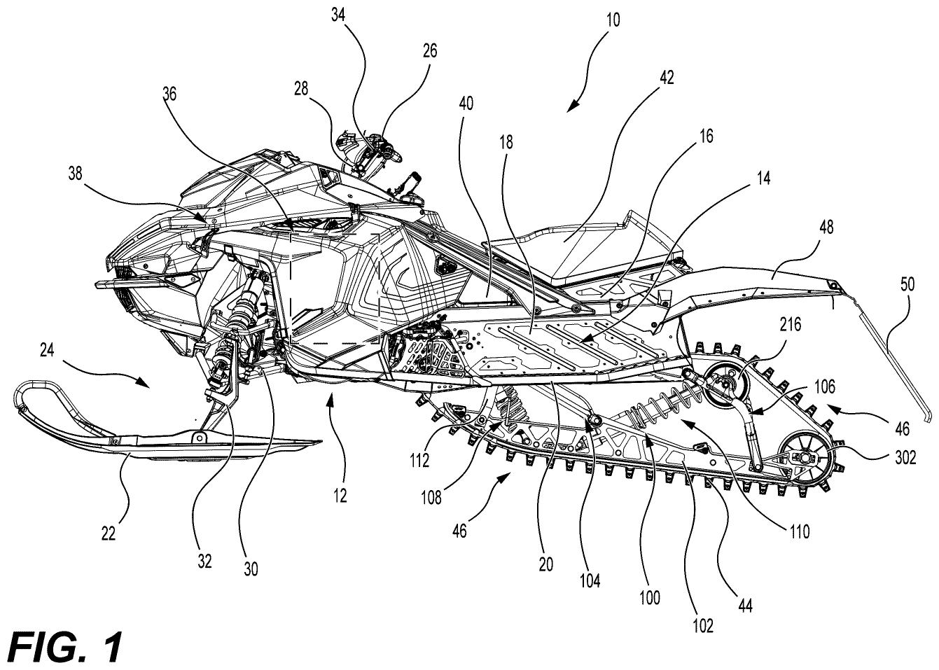

The present technology will be described with reference to a snowmobile 10. With reference to FIG. 1, the snowmobile 10 has a frame 12. The frame 12 has a tunnel 14 having a top 16 and left and right sides 18 (only the left side 18 being shown). Left and right footrests 20 (only the left footrest 20 being shown) extend laterally outward from the left and right sides 18 of the tunnel 14 respectively. Left and right skis 22 (only the left ski 22 being shown) are connected to the frame 12 via left and right front suspensions 24 (only the left front suspension being shown) respectively. A handlebar 26 is used to steer the skis 22. The handlebar 26 is connected to a steering column 28 which connects to the skis 22 via tie rods 30 and ski legs 32 (only the left tie rod 30 and ski leg 32 being shown). A throttle lever (not shown) is connected to a right side of the handlebar to control a speed of the snowmobile 10 and a brake lever 34 is connected to a left side of the handlebar 26 to brake the snowmobile 10. A motor 36 (schematically shown) is connected to the frame 12 forward of the tunnel 14. In the present embodiment, the motor 36 is an internal combustion engine, but it is contemplated that the motor 36 could be an electric motor. An air intake system, an exhaust system, and an electrical system (all not shown) are connected to the motor 36. The motor 36 drives a continuously variable transmission (CVT) which drives a transverse jackshaft, which drives a reduction drive, which drives a transverse driveshaft having drive sprockets thereon (all not shown). Body panels 38 are connected to the frame 12 to define a motor compartment inside which the motor 36 and at least some of its associated components are disposed. A fuel tank 40 is mounted to the top 16 of the tunnel 14. A straddle seat 42 is mounted on top of the fuel tank 40. A snowmobile rear suspension 100 is operatively connected to the tunnel 14 as will be described in more detail below. An endless track 44 having a plurality of lugs 46 thereon is provided around the snowmobile rear suspension 100 and the drive sprockets. The endless track 44 is driven by the motor 36 via the drive sprockets and the aforementioned components. As can be seen, the snowmobile rear suspension 100 and the endless track 44 are partially covered by the tunnel 14 and extends rearward from the tunnel 14. A tunnel extension 48 is connected to and extends rearward from the tunnel 14 to extend over the snowmobile rear suspension 100 and the endless track 44. A snow flap 50 is connected to the rear end of the tunnel extension 48.

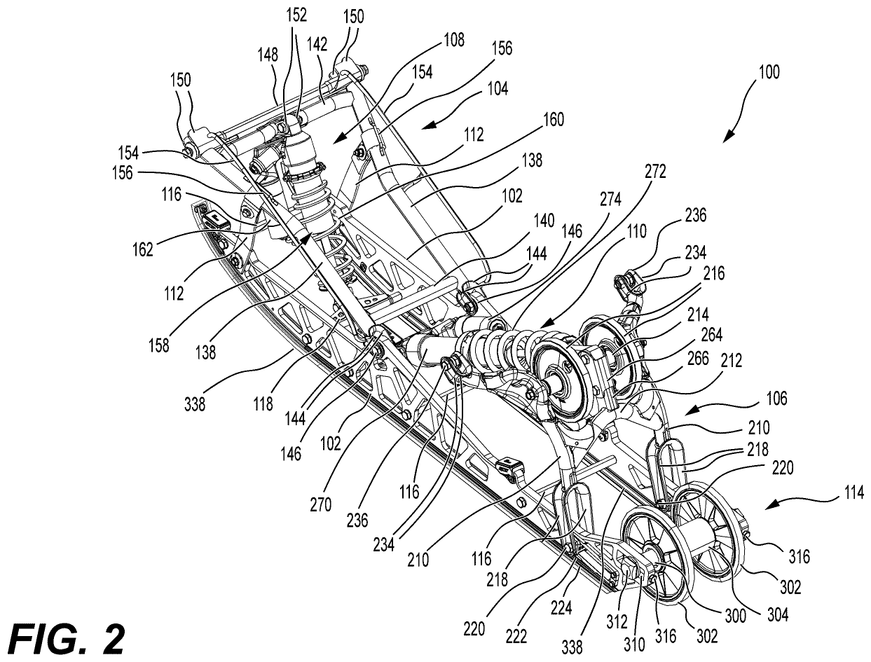

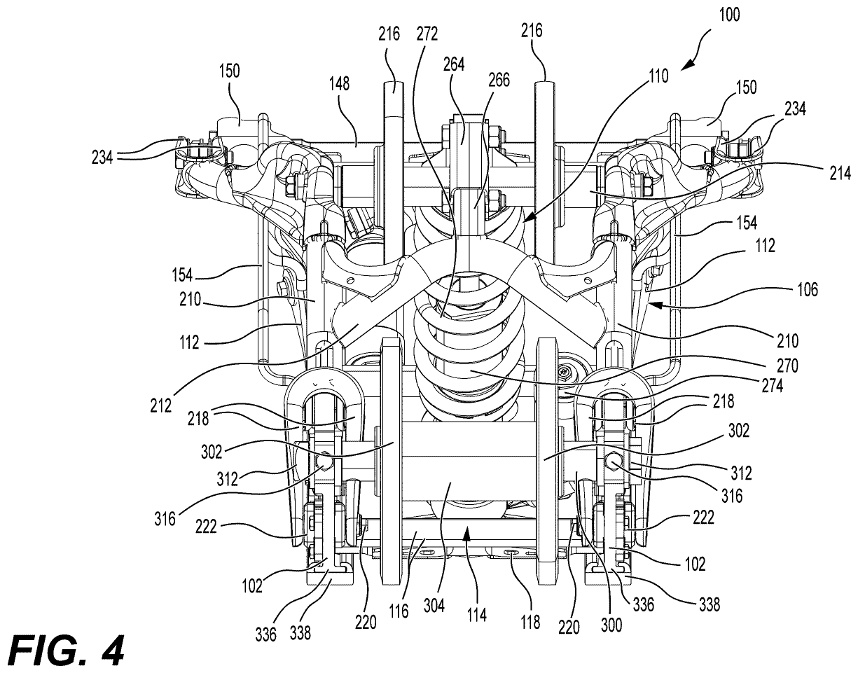

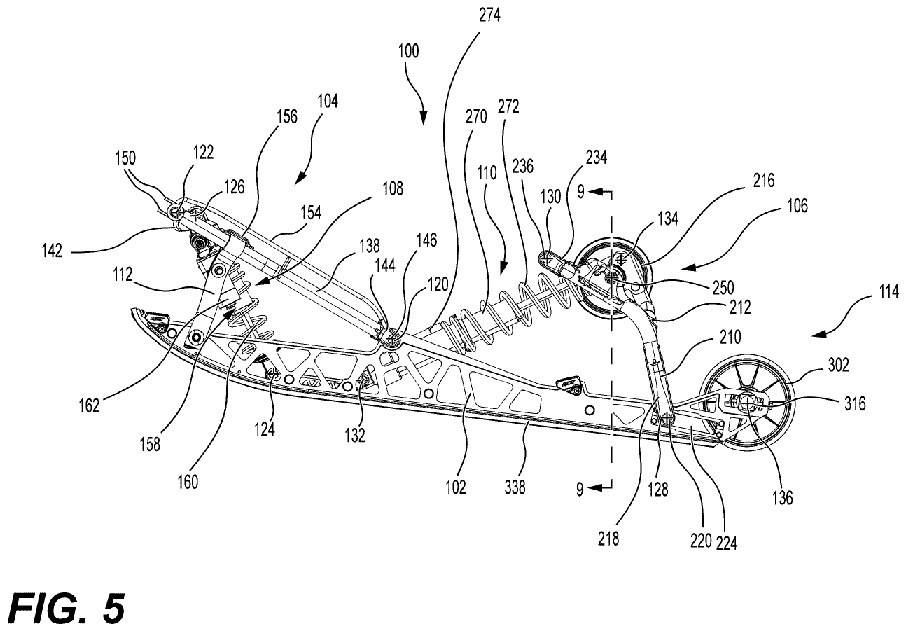

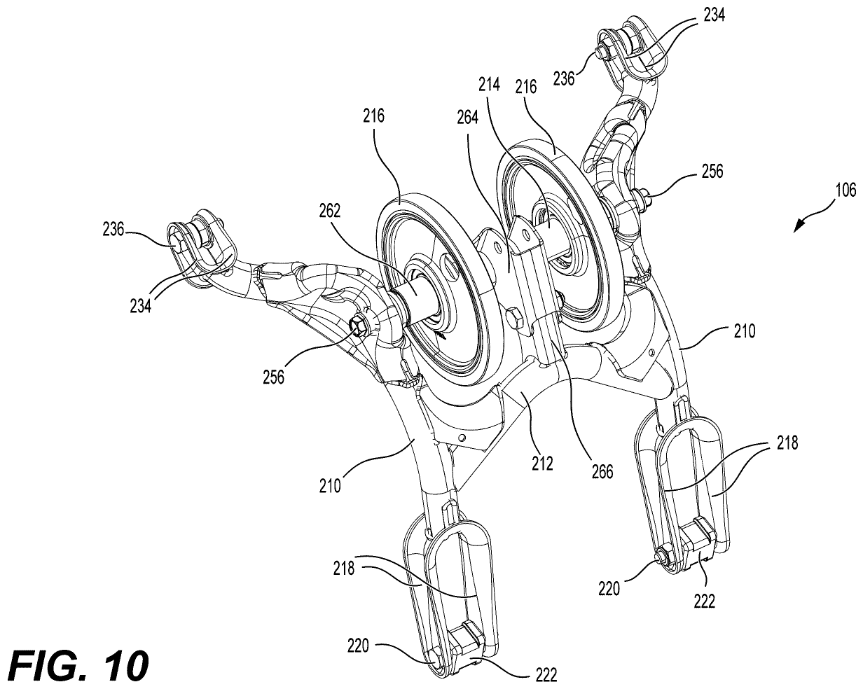

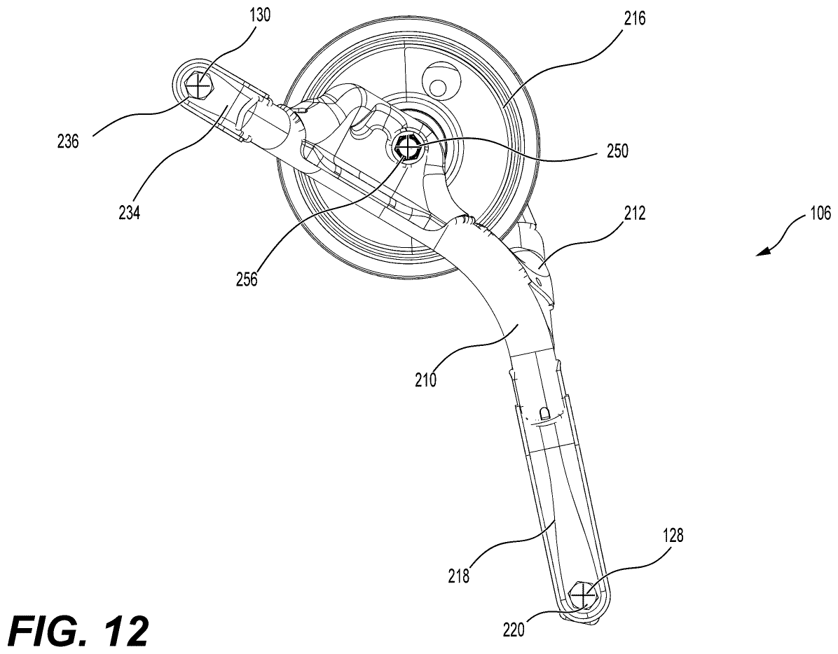

Turning now to FIGS. 2 to 15, the snowmobile rear suspension 100 (hereinafter the rear suspension 100) will be described in more detail. The rear suspension 100 has left and right slide rails 102, front and rear suspensions arm assemblies 104, 106, front and rear shock absorber assemblies 108, 110, front left and right stopper straps 112, and a rear idler wheel assembly 114.

The left and right slide rails 102 are connected to each other by three rods 116 and a H-shaped bracket 118. The H-shaped bracket 118 will be described in more detail below.

The front suspension arm assembly 104 is pivotally connected to the left and right slide rails 102 about a laterally extending axis 120 and to the sides 18 of the tunnel 14 about a laterally extending axis 122. The front suspension arm assembly 104 extends upward and forward from the laterally extending axis 120 to the laterally extending axis 122.

The front shock absorber assembly 108 is pivotally connected to the H-shaped bracket 118 about a laterally extending axis 124 and to the front suspension arm assembly 104 about a laterally extending axis 126. The front shock absorber assembly 104 extends upward and forward from the laterally extending axis 124 to the laterally extending axis 126.

The front stopper straps 112 are connected between the front suspension arm assembly 104 and the left and right slide rails 102 for limiting by how much the front suspension arm assembly 104 can pivot away from the slide rails 102 about the laterally extending axis 120.

The rear suspension arm assembly 106 is pivotally connected to the left and right slide rails 102 about a laterally extending axis 128 and to the sides 18 of the tunnel 14 about a laterally extending axis 130. The rear suspension arm assembly 106 extends upward and forward from the laterally extending axis 128 to the laterally extending axis 130. As will be described in more detail below, a position of the laterally extending axis 128 can change longitudinally.

The rear shock absorber assembly 110 is pivotally connected to the H-shaped bracket 118 about a laterally extending axis 132 and to the rear suspension arm assembly 106 about a laterally extending axis 134. The rear shock absorber assembly 110 extends upward and rearward from the laterally extending axis 132 to the laterally extending axis 134.

The rear idler wheel assembly 114 is connected to the left and right slide rails 102 about a rear axle axis 136. As will be described in more detail below, a position of the rear idler wheel assembly 114, and therefore of the rear axle axis 136, is adjustable longitudinally in order to adjust tension in the endless track 44.

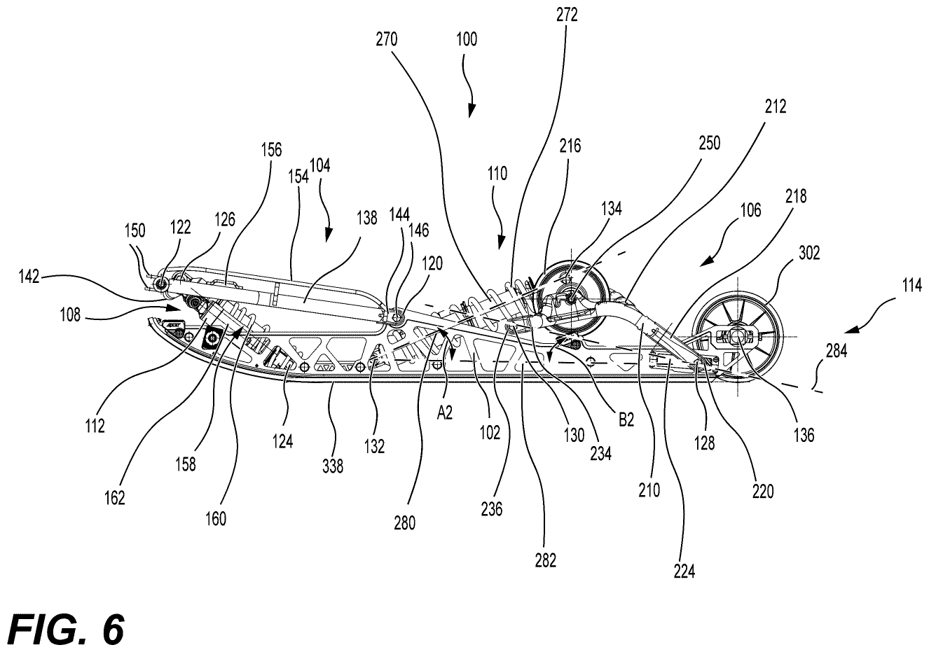

The rear suspension 100 is movable between a decompressed configuration and a plurality of compressed configurations. The decompressed configuration is shown in FIGS. 1 to 5 and 7 to 9. The decompressed configuration is the state of the rear suspension 100 when the snowmobile 10 is at rest without any load applied to the snowmobile 10, such as the weight of a passenger for example. In the present embodiment, in the decompressed configuration, the front stopper straps 112 are in tension. One compressed configuration is shown in FIG. 6. A compressed configuration is a state of the rear suspension 100 when, from the decompressed configuration, the front suspension arm assembly 104 has pivoted about the laterally extending axis 120 toward the slide rails 102 and the rear suspension arm assembly 106 has pivoted about the laterally extending axis 128 toward the slide rails 102.

With reference to FIGS. 2, 3, 5, 8 and 9, the front suspension arm assembly 104 will now be described in more detail. The front suspension arm assembly 104 has left and right arms 138, a lower cross-member 140 connected to and extending laterally between the left and right arms 138 near lower ends thereof, and an upper cross-member 142 connected to and extending laterally between the left and right arms 138 near upper ends thereof.

Lower left fingers 144 are connected to the lower end of the left arm 138. The left slide rail 102 is received between the lower left fingers 144. A fastener 146 connects the lower left fingers 144 to the left slide rail 102 such that the left arm 138 pivots about the laterally extending axis 120. Similarly, lower right fingers 144 are connected to the lower end of the right arm 138. The right slide rail 102 is received between the lower right fingers 144. A fastener 146 connects the lower right fingers 144 to the right slide rail 102 such that the right arm 138 pivots about the laterally extending axis 120. As can be seen, the laterally extending axis 120 extends through the slide rails 102.

A rod 148 is connected to and extends between the left and right sides 18 of the tunnel 10. The rod 148 defines the laterally extending axis 122 which extends through the left and right sides 18 of the tunnel 10. Upper left fingers 150 are connected to the upper end of the left arm 138. The left end of the rod 148 is received between the upper left fingers 150 such that the left arm 138 pivots about the laterally extending axis 122. Similarly, upper right fingers 150 are connected to the upper end of the right arm 138. The right end of the rod 148 is received between the upper right fingers 150 such that the right arm 138 pivots about the laterally extending axis 122.

The upper cross-member 142 has brackets 152 connected to a middle thereof. The brackets 152 connect the upper end of the front shock absorber assembly 108 to the front suspension arm assembly 104 as will be described in more detail below. It is contemplated that in some embodiments, the brackets 152 or only one bracket 152 could be connected to a right or a left of the upper cross-member 142.

For each of the left and right sides of the front suspension arm assembly 104, a rod 154 is connected between a top one of the upper fingers 150 and a laterally outward one of the lower fingers 144. The rods 154 prevent the endless track 44 from sliding against the arms 138. For each of the left and right arms 138, a C-shaped rod 156 is connected to the top of the arm 138. The front stopper straps 112 are looped around the arms 138 and pass between the arms 138 and the C-shaped rods 156. As such, the rods 156 limit sliding of the front stopper straps 112 along the arms 138.

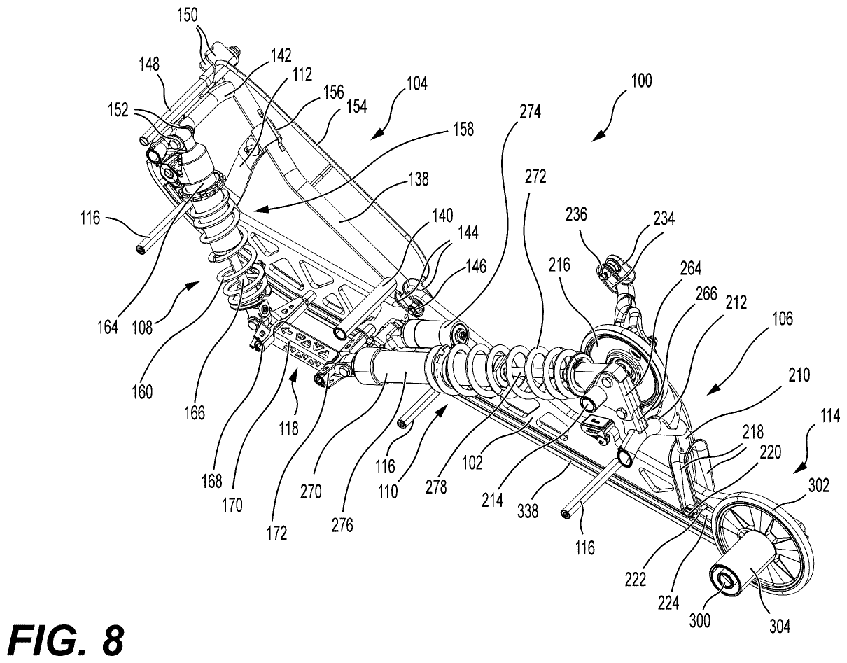

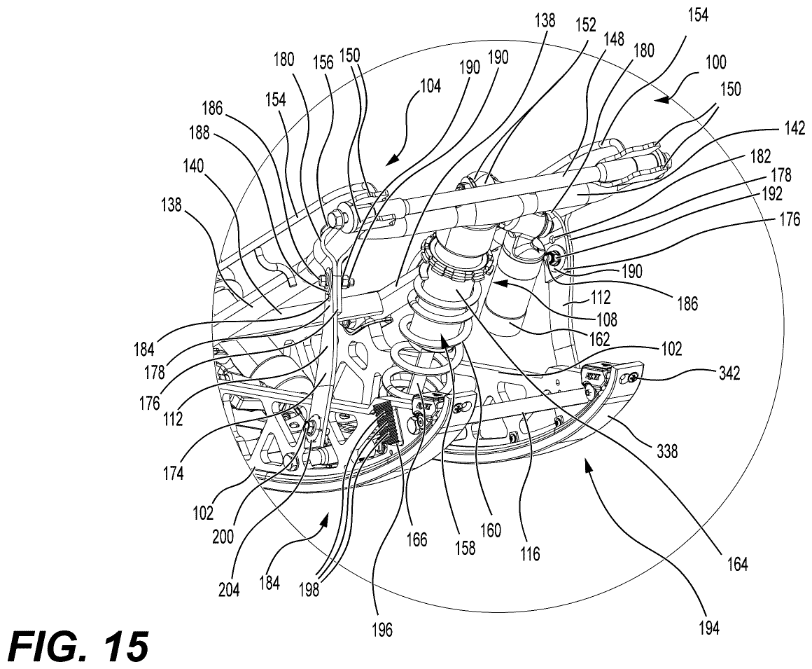

With reference to FIGS. 8 and 15, the front shock absorber assembly 108 will be described in more detail. The front shock absorber assembly 108 includes a front shock absorber 158, a front coil spring 160 and a front external reservoir 162. The front shock absorber 158 is a hydraulic shock absorber having a cylinder 164, a piston (not shown) inside the cylinder 164, and a piston rod 166 connected to the piston and extending from a lower end of the cylinder 164. The front shock absorber 158 extends inside the front coil spring 160. The front coil spring 160 is connected to the front shock absorber 158. More specifically, the front coil spring 160 is connected between the cylinder 164 and the piston rod 166 such that when the front shock absorber 158 is compressed (i.e., the piston rod 166 slides into the cylinder 164) the front coil spring 160 is compressed. The front external reservoir 162 is mounted to the cylinder 164 and fluidly connects to the cylinder 164 to permit flow of hydraulic fluid between the cylinder 164 and the front external reservoir 162. It is contemplated that in some embodiments the external reservoir 162 could be omitted.

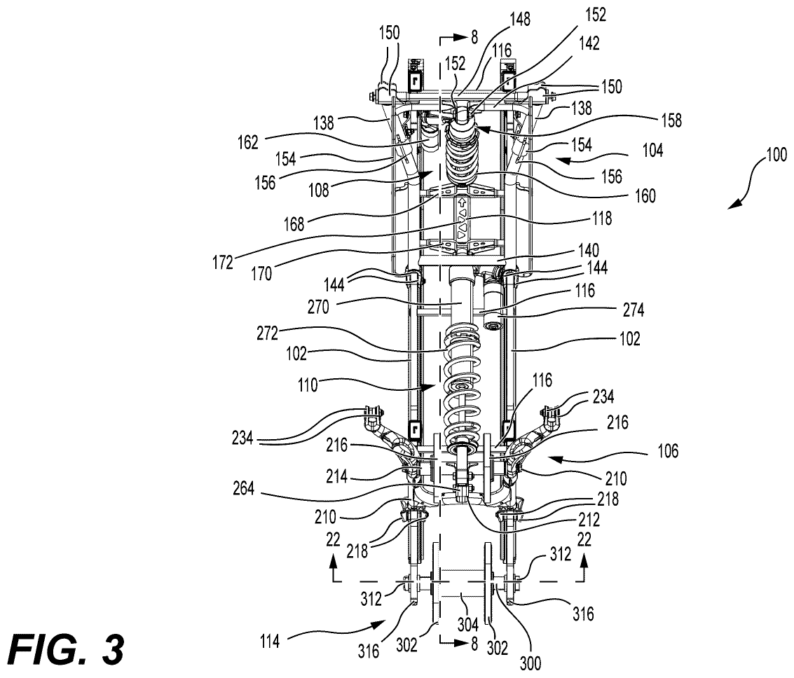

As best seen in FIGS. 3 and 8, the H-shaped bracket 118 has front and rear arms 168, 170 extending laterally between the left and right slide rails 102, and a longitudinal arm 172 extending longitudinally between the front arm 168 and the rear arm 170. It is contemplated that in some embodiments the longitudinal arm 172 could be omitted such that the front and rear arms 168, 170 would become two separate brackets. The lower end of the piston rod 166 of the front shock absorber 158 is pivotally connected to the front arm 168 of the bracket 118 about the laterally extending axis 124, which extends through the slide rails 102. A connection between the lower end of the piston rod 166 and the front arm 168 is such that it provides a single degree of freedom: rotation about the laterally extending axis 124 relative to the slide rails 102.

The upper end of the cylinder 164 of the front shock absorber 158 is pivotally connected to the upper cross-member 142 via the brackets 152 about the laterally extending axis 126, which extends through the sides 18 of the tunnel 14. A connection between the upper end of the cylinder 164 and the brackets 152 is such that it provides a single degree of freedom: rotation about the laterally extending axis 126 relative to the upper cross-member 142.

Turning now to FIG. 15, the front right stopper strap 112 and portions of the right slide rail 102 and if the right arm 138 to which the front right stopper strap 112 attaches will be described in more detail. The front left stopper strap 112 is a mirror image of the front right stopper strap 112, and as such will not be described in detail. It should be understood that for each “right” component of the right stopper strap 112 and associated components used to attach it, there is a corresponding “left” component that has been labeled with the same reference numeral in FIG. 15 (when visible).

The front right stopper strap 112 has a right stopper strap body 174. In the present embodiment, the right stopper strap body 174 is made from leather, but other materials are contemplated.

One end of the right stopper strap body 174 is passed over the right arm 138, inserted through the space defined between the right arm 138 and the right C-shaped rod 156, and then brought down such that two portions 176, 178 of the front right stopper strap 112 overlap each other, and a right loop 180 is formed through which the right arm 138 extends. The portion 176 defines two aperture 182 (corresponding to one of which is visible for the front left stopper strap 118 in FIG. 15) and the portion 178 defines two apertures 184 (one of which is visible in FIG. 15). The apertures 182, 184 are used to adjust a length of the front right stopper strap 112. An upper right fastener 186 extends through a washer 188 disposed between the head of the upper right fastener 186 and the portion 178, through one of the apertures 182, through one of the apertures 184, and through a washer 190. A nut 192 is fastened to the end of the fastener 186 such that the washer 190 is between the nut 192 and the portion 176, thereby fastening the portions 176, 178 to each other. It is contemplated that one or both portions 176, 178 could have more than two apertures 182, 184, thereby providing for more length adjustment of the front right stopper strap 112. It is also contemplated that one of the portions 176, 178 could have a single aperture 176, 178. It is also contemplated that both portions 176, 178 could have a single aperture 178, 178, thereby not permitting adjustment of the front right stopper strap 112 via the upper portion of the right stopper strap 112. It is contemplated that instead of being loop around the right arm 138, the front right stopper strap 112 could be looped around the right part of the upper cross-member 142. It is also contemplated that the upper end of the front right stopper strap 112 could be connected to the front suspension arm assembly 104 by means other than the above-described loop 180. For example, the end of the right stopper strap body 174 could be fastened directly to the right arm 138 or to a bracket connected to the right arm 138.

The lower end of the right stopper strap body 174, which corresponds to the lower end of the front right stopper strap 112, is connected to a right side of an upturned front end portion 194 of the right slide rail 102 such that a left side of the right stopper strap body 174 abuts a right rough surface 196 on the right side of the slide rail 102. In the present embodiment, the rough surface 196 is integrally formed with the upturned front end portion 194 of the right slide rail 102, but it is contemplated that it could be defined on a part that is connected to the upturned front end portion 194 of the right slide rail 102. It is contemplated that in an alternative embodiment, the lower end of the right stopper strap body 174 could be connected to a left side of the upturned front end portion 194 of the right slide rail 102 such that a right side of the right stopper strap body 174 abuts a rough surface 196 on the left side of the slide rail 102. The right rough surface 196 defines three right surface aperture 198 disposed in line at different vertical positions. The surface apertures permit adjustment of a position of the front right stopper strap 112. It is contemplated that the right rough surface 196 could define two or more than three surface apertures 198. It is also contemplated that a single surface aperture 198 could be defined in the right rough surface 196. It is also contemplated that the right surface apertures 198 could be arranged other than in line. A lower right strap aperture (not visible in FIG. 15) is defined in the lower portion of the front right stopper strap 112. A lower right fastener 200 extends through a washer 202 disposed between the head of the lower right fastener 200 and the lower end of the front right stopper strap 112, through the lower right strap aperture, and into one of the right surface apertures 198 inside which it is fastened. The rough surface 196 digs into the right stopper strap body 174 thereby providing a secure connection between the front right stopper strap 112 and the right slide rail 102. It is contemplated that the lower portion of the front right stopper strap 112 could define more than one lower right strap aperture to provide additional adjustment of the front right stopper strap 112. In the present embodiment, the right rough surface 196 is a right toothed surface having a plurality of longitudinally extending right teeth arranged in a vertical stack. It is contemplated that in alternative embodiments, the right rough surface 196 could be defined by other features. For example, the right rough surface 196 could be defined by a pattern of diamond-shaped teeth or by random protrusions.

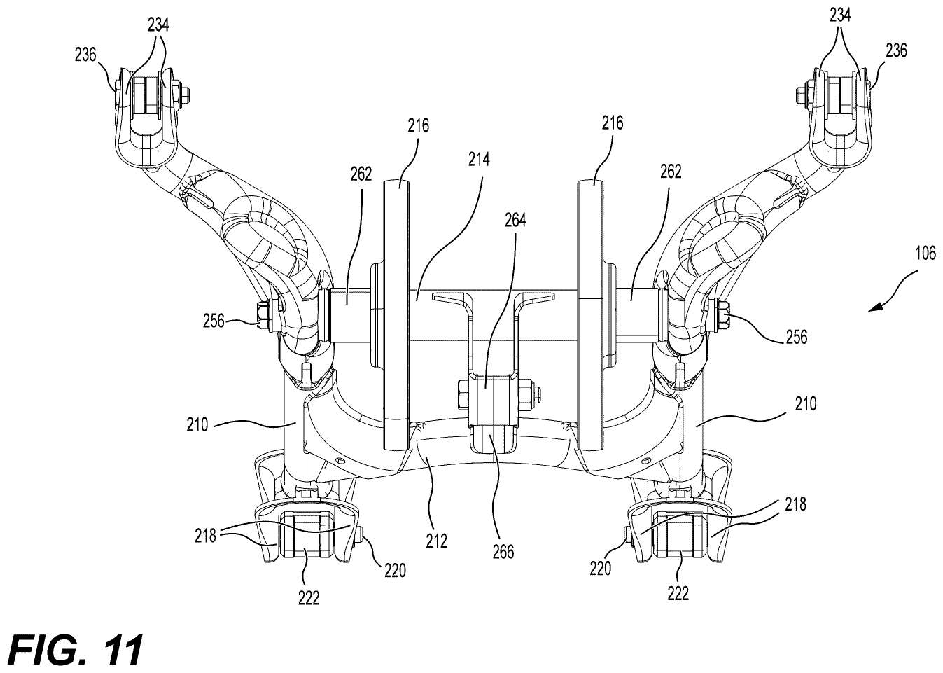

With reference to FIGS. 2 to 14, the rear suspension arm assembly 106 will now be described in more detail. The rear suspension arm assembly 106 has left and right arms 210, a cross-member 212 connected to and extending laterally between the left and right arms 210 near lower ends thereof, an axle 214 connected to and extending laterally between the left and right arms 210 at a position between the upper and lower ends of the arms 210, and two idler wheels 216 mounted to the axle 214. As best seen in FIG. 11, the left and right arms 210 extend generally straight from their lower ends to the position of the axle 214, then bend and extend diagonally to their upper ends. The cross-member 212 is disposed between the axle 214 and the lower ends of the arms 210. Both the cross-member 212 and the axle 214 are disposed between the laterally extending axis 128 and the laterally extending axis 130. As can be seen in FIG. 1, the idler wheels 216 roll along an inside surface of the endless track 44.

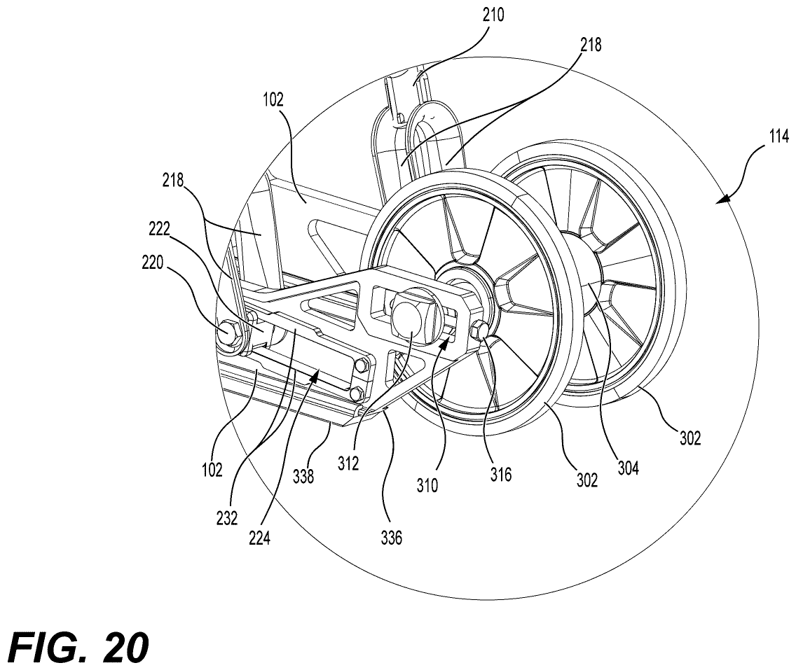

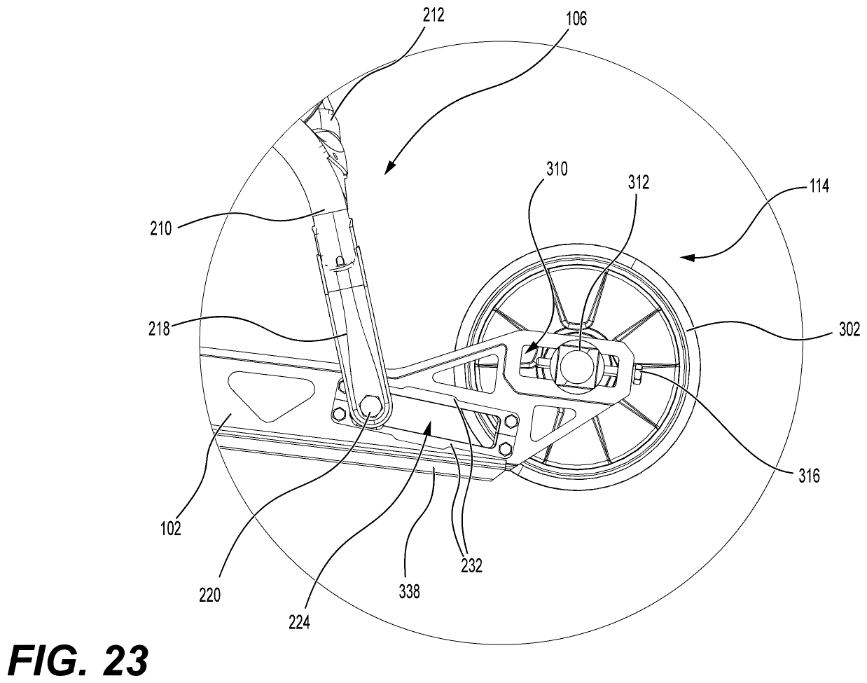

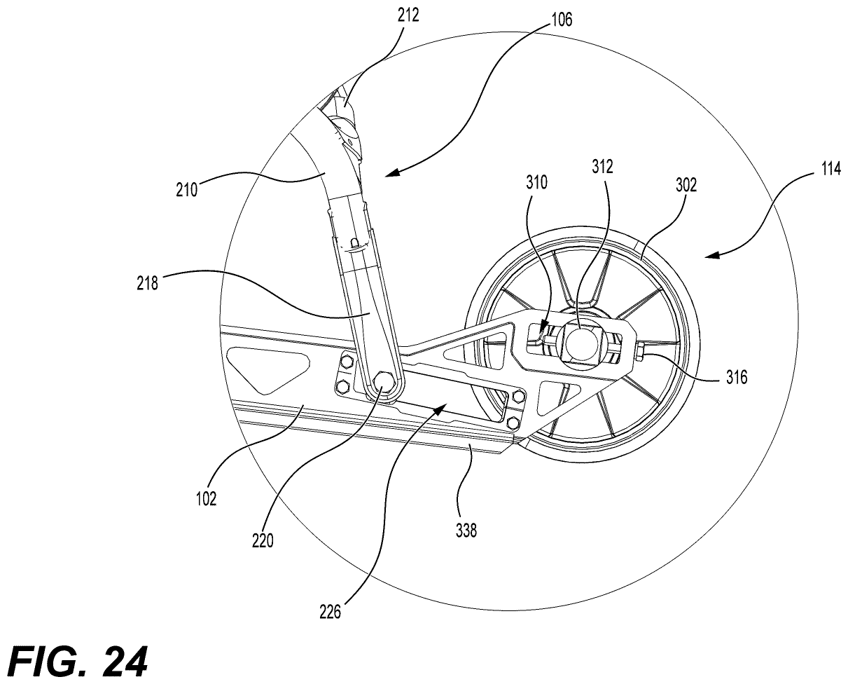

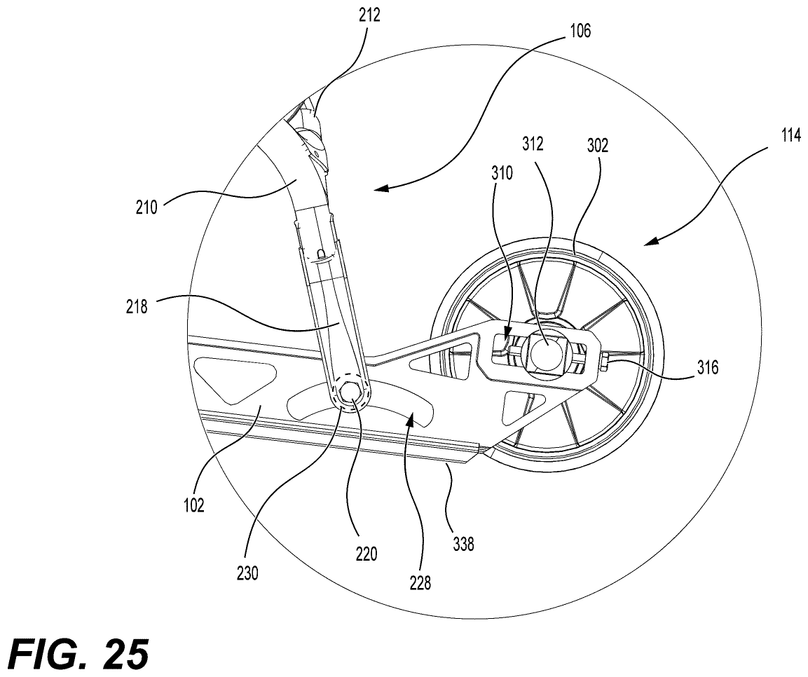

Lower left fingers 218 are connected to the lower end of the left arm 210. The left slide rail 102 is received between the lower left fingers 218. A rear left fastener 220 extends through the lower left fingers 218 and the left slide rail 102 to connect the lower left fingers 218 to the left slide rail 102 such that the left arm 210 pivots about the laterally extending axis 128. More specifically, as shown in FIGS. 20, 21 and 23, the rear left fastener 220 extends through a left sleeve 222 disposed between the rear left fingers 218 and disposed in a rear left slot 224 defined in the left slide rail 102. In the present amendment, the left sleeve 222 is a left slider block 222 and the rear left slot 224 is a linear slot 224. Similarly, lower right fingers 218 are connected to the lower end of the right arm 210. The right slide rail 102 is received between the lower right fingers 218. A rear right fastener 220 extends through the lower right fingers 218 and the right slide rail 102 to connect the lower right fingers 218 to the right slide rail 102 such that the right arm 210 pivots about the laterally extending axis 128. More specifically, the rear right fastener 220 extends through a right sleeve 222 disposed between the rear right fingers 218 and disposed in a rear right slot 224 defined in the right slide rail 102. In the present amendment, the right sleeve 222 is a right slider block 222 and the rear right slot 224 is a linear slot 224. The laterally extending axis 128 extends through the slide rails 102 and since the slider blocks 222 slide inside the rear slots 224, the laterally extending axis 128 also moves longitudinally, thereby varying the geometry and damping characteristics of the rear suspension 100. In an alternative embodiment illustrated in FIG. 24, the linear slots 224 have been replaced with longer linear slots 226 which provide a different varying the geometry and damping characteristics of the rear suspension. In another alternative embodiment illustrated in FIG. 25, the linear slots 224 have been replaced with arcuate slots 228 which provide a different varying the geometry and damping characteristics of the rear suspension, and in order to properly follow the arcuate slots 228, the slider blocks 222 have been replaced with rollers 230. With reference to FIGS. 20, 21 and 23, covers 232 are fastened to the slide rails 102 to protect the edges of the rear slots 224 from wear due to the sliding of the slider blocks 222 inside the rear slots 224. It is contemplated that in some embodiments, the covers 232 could be omitted.

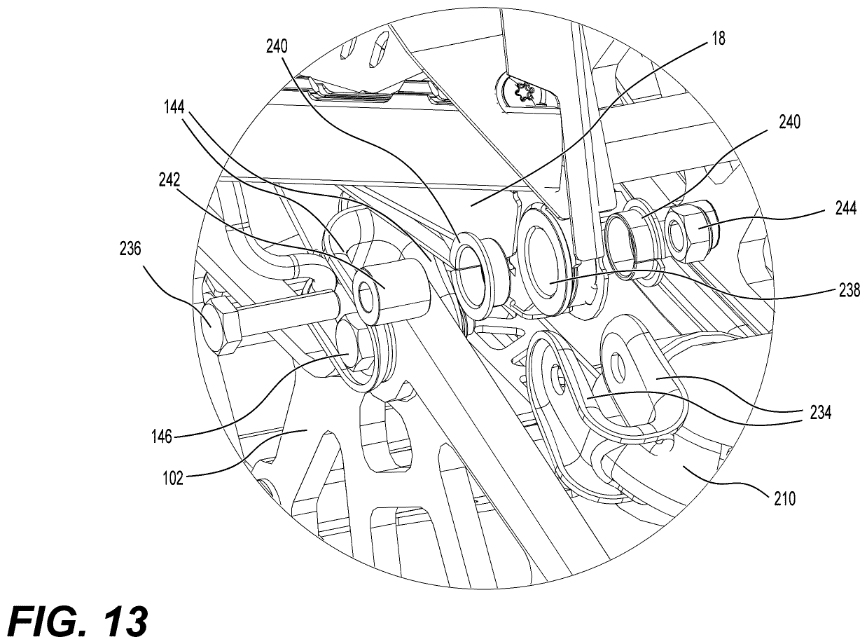

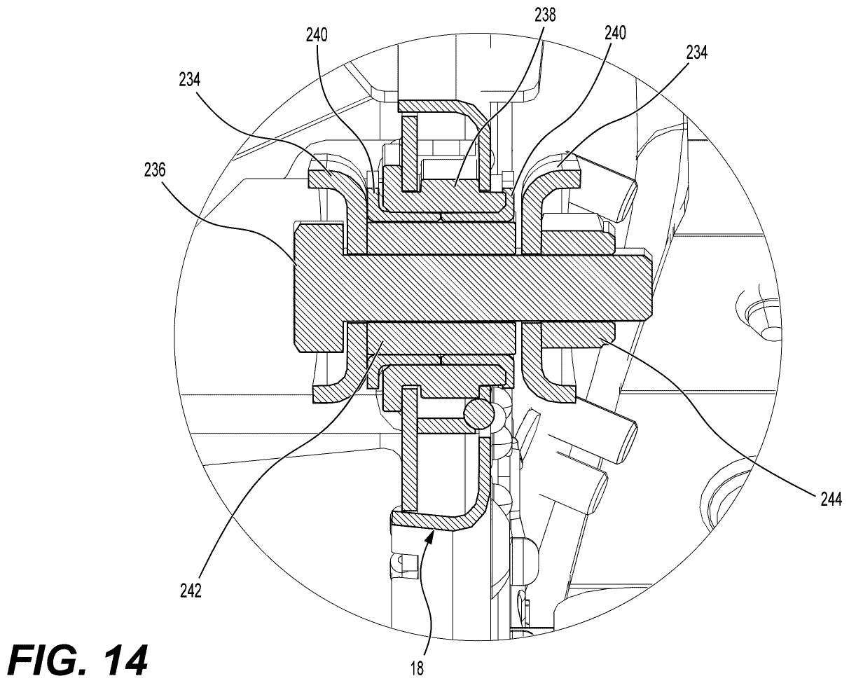

Upper left fingers 234 are connected to the upper end of the left arm 210. The left side 18 of the tunnel 14 is received between the upper left fingers 234. A rear left fastener 236 extends through the upper left fingers 234 and the left side 18 of the tunnel 14 to connect the upper left fingers 234 to the left side 18 of the tunnel 14 such that the left arm 210 pivots about the laterally extending axis 130. With reference to FIGS. 13 and 14, an eyelet 238 is provided in a bottom, rear corner of the left side 18 of the tunnel 14. Two bushings 240 are inserted in the eyelet 238 and a sleeve 242 is inserted in the bushings 240. The eyelet 238, the bushings 240 and the sleeve 242 are disposed laterally between the upper left fingers 234. The rear left fastener 236 extends through the upper left fingers 234, the eyelet 238, the bushings 240 and the sleeve 242 and a nut 244 is fastened to the end of the rear left fastener 236. Similarly, upper right fingers 234 are connected to the upper end of the right arm 210. The right side 18 of the tunnel 14 is received between the upper right fingers 234. A rear right fastener 236 extends through the upper right fingers 234 and the right side 18 of the tunnel 14 to connect the upper right fingers 234 to the right side 18 of the tunnel 14 such that the left arm 210 pivots about the laterally extending axis 130. Although not shown in detail, an eyelet 238, bushings 240 and a sleeve 242 are also provided for the connection of the upper right fingers 234 to the right side 18 of the tunnel 14. As such, the laterally extending axis 130 extends through the left and right sides 18 of the tunnel 10.

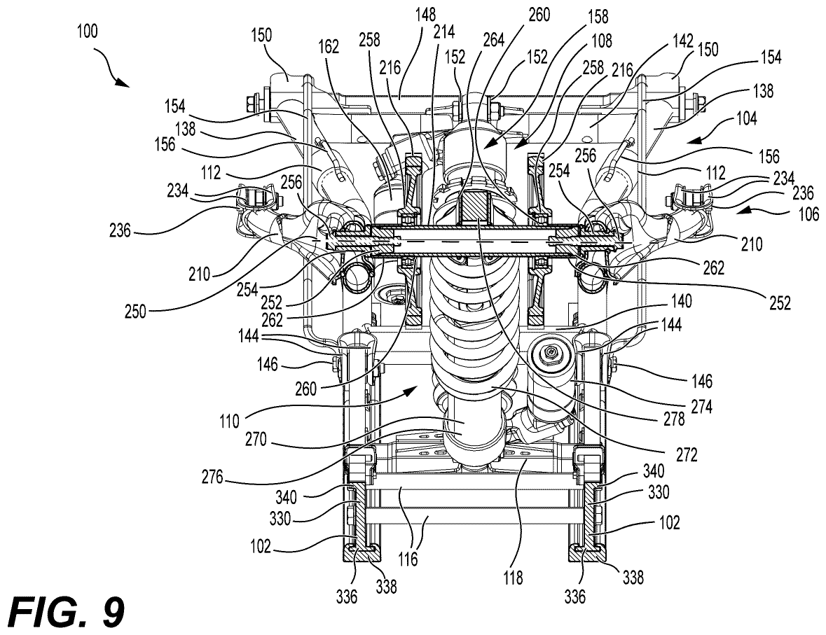

With reference to FIG. 9, the manner in which the axle 214 is connected to the arms 210 and the manner in which the idler wheels 216 are mounted to the axle 214 will be described in more detail. The axle 214 is hollow and defines an axle axis 250.

Plugs 252 are provided in the ends of the axle 214. In the present embodiment, the plugs 252 are welded to the axle 214, but it is contemplated they could be connected to the axle 214 by other means. Inserts 254 are inserted in the arms 210. Fasteners 256 are inserted through the inserts 254 and the plugs 252 to fasten the axle 214 to the arms 210.

For each idler wheel 216, a ball bearing 258 is mounted radially between the axle 214 and the idler wheel 216. The laterally inner side of an inner race to the bearing 258 abuts a small step 260 defined by the axle 214. A sleeve 262 is provided around the axle 214. The sleeve 262 abuts the arm 210 on one side and the laterally outer side of the inner race of the bearing 258 on the other side. The step 260 and the sleeve 262 prevent the bearing 258 from moving axially along the axle axis 250.

A bracket 264 is connected to the axle 214 between the two idler wheels 216 and to the cross-member 212. The bracket 264 is welded to the axle 214, but it is contemplated it could be connected to the axle 214 by other means. The bracket 264 is fastened to an arm 266 extending from a center of the cross-member 212 as best seen in FIG. 8. The bracket 264 connect the upper end of the rear shock absorber assembly 110 to the rear suspension arm assembly 106 as will be described in more detail below.

With reference to FIGS. 8 and 9, the rear shock absorber assembly 110 will be described in more detail. The rear shock absorber assembly 110 includes a rear shock absorber 270, a rear coil spring 272 and a rear external reservoir 274. The rear shock absorber 270 is a hydraulic shock absorber having a cylinder 276, a piston (not shown) inside the cylinder 276, and a piston rod 278 connected to the piston and extending from an upper end of the cylinder 276. The rear shock absorber 270 extends inside the rear coil spring 272. The rear coil spring 272 is connected to the rear shock absorber 270. More specifically, the rear coil spring 272 is connected between the cylinder 276 and the piston rod 278 such that when the rear shock absorber 270 is compressed (i.e., the piston rod 278 slides into the cylinder 276) the rear coil spring 272 is compressed. In the present embodiment, the rear shock absorber 270 has a central axis 280 that passes through the laterally extending axes 132, 134. The rear external reservoir 274 is mounted to the cylinder 276 and fluidly connects to the cylinder 276 to permit flow of hydraulic fluid between the cylinder 276 and the front external reservoir 274.

The lower end of the cylinder 276 of the rear shock absorber 270 is pivotally connected to the rear arm 172 of the bracket 118 about the laterally extending axis 132, which extends through the slide rails 102. A connection between the lower end of the cylinder 276 and the rear arm 172 is such that it provides a single degree of freedom: rotation about the laterally extending axis 132 relative to the slide rails 102.

The upper end of the piston rod 278 of the rear shock absorber 270 is pivotally connected to the axle 214 and the cross-member 212 via the bracket 264 about the laterally extending axis 134, which extends through the idler wheels 216. A connection between the upper end of the piston rod 278 and the bracket 264 is laterally between the idler wheels 216. The connection between the upper end of the piston rod 278 and the bracket 264 is such that it provides a single degree of freedom: rotation about the laterally extending axis 134 relative to the axle 214 and the cross-member 212.

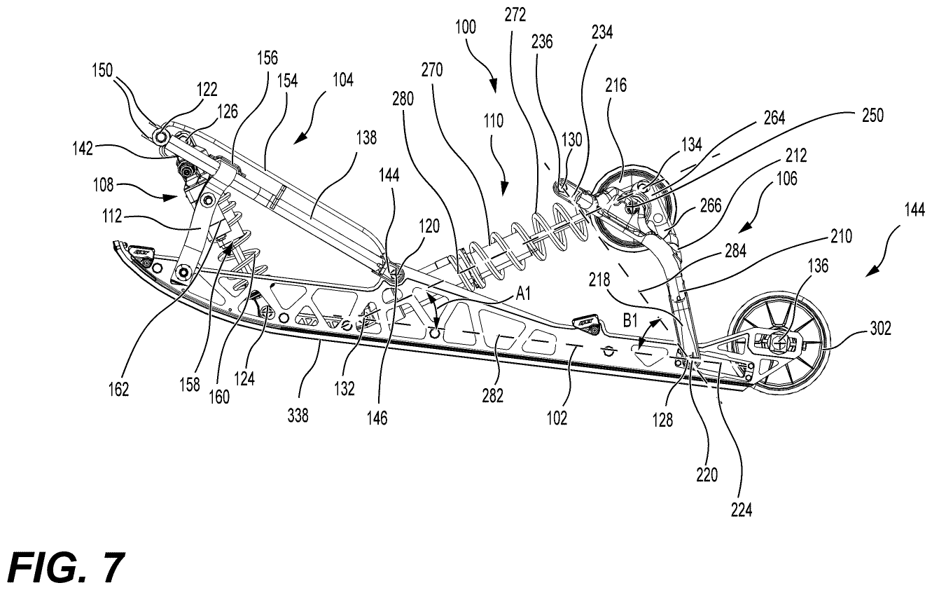

The relative position between some of the axes and components described above when the rear suspension 100 is in the decompressed configuration will now be described with reference to FIG. 7. The axle axis 250 and the cross-member 212 are both vertically between the laterally extending axis 132 and the laterally extending axis 134. The central axis 280 of the rear shock absorber 270 passes under the laterally extending axis 130. The laterally extending axis 134 is vertically lower than the laterally extending axis 130. It is contemplated that is some embodiments, laterally extending axis 134 could be vertically higher than the laterally extending axis 130. The laterally extending axes 130, 134 are both vertically higher than the laterally extending axes 128, 132. The central axis 280 is at an angle A1 relative to a plane 282 containing the laterally extending axes 128, 132. A plane 284 containing the laterally extending axes 128, 130 is at an angle B1 relative to the plane 282. The angle A1 is smaller than the angle B1.

The relative position between some of the axes and components described above when the rear suspension 100 is in the compressed configuration shown in FIG. 6 will now be described with reference to FIG. 6. The axle axis 250 and the cross-member 212 are both vertically between the laterally extending axis 132 and the laterally extending axis 134. The central axis 280 of the rear shock absorber 270 passes over the laterally extending axis 130. The laterally extending axis 134 is vertically higher than the laterally extending axis 130. The laterally extending axes 130, 134 are both vertically higher than the laterally extending axes 128, 132. The central axis 280 is at an angle A2 relative to the plane 282. The angle A2 is smaller than the angle A1. The plane 284 is at an angle B2 relative to the plane 282. The angle B2 is smaller than the angle B1. The angle A2 is larger than the angle B2.

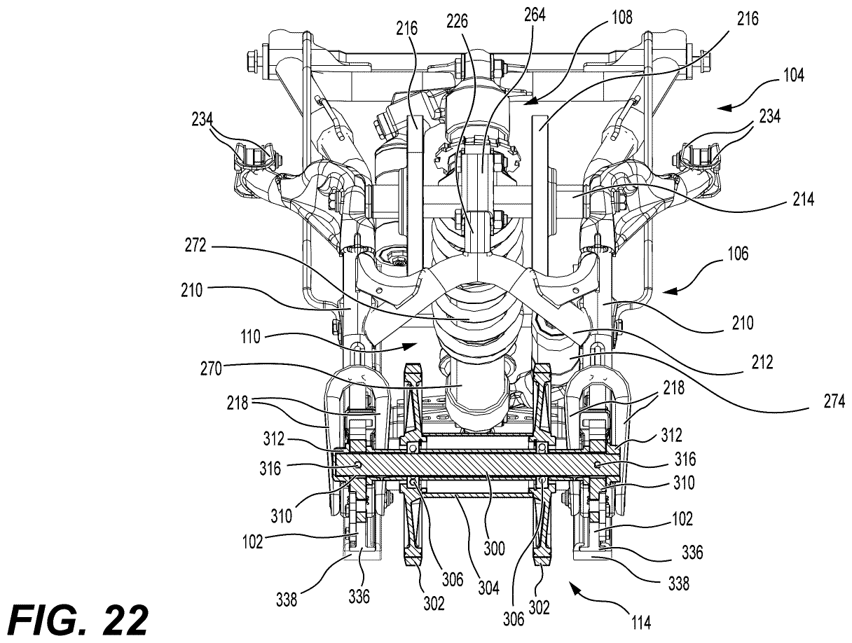

With reference to FIGS. 20 to 23, the rear idler wheel assembly 114 will be described in more detail. The rear idler wheel assembly 114 has a rear axle 300, two rear idler wheels 302 rotationally connected to the rear axle 300, and a tube 304 disposed laterally between and connected to the rear idler wheels 302. Ball bearings 306 are connected radially between the rear idler wheels 302 and the rear axle 300. The rear axle 300 defines the rear axle axis 136 and extends through the bearings 306 and the tube 304. It is contemplated that the tube 304 could be omitted. It is contemplated that the rear idler wheel assembly 114 could have a single rear idler wheel 302 or more than two rear idler wheels 302.

The rear axle 300 is connected to and extends laterally between the left and right slide rails 102. A rear end portion 308 of the left slide rail 102 defines a rear left tensioner slot 310 and a rear end portion 308 of the right slide rail 102 defines a rear right tensioner slot 310. The tensioner slots 310 are linear slots. The left end of the rear axle 300 extends in and is supported by the rear left tensioner slot 310 and the right end of the rear axle 300 extends in and is supported by the rear right tensioner slot 310. A left fastener 312, in this embodiment a left threaded cap 312, is connected to the left end of the rear axle 300 and abuts a left side of the left slide rail 102. A right fastener 312, in this embodiment a right threaded cap 312, is connected to the right end of the rear axle 300 and abuts a right side of the right slide rail 102. A diameter of the threaded caps 312 is greater than a height of the tensioner slots 320. As such, the threaded caps 312 prevent the rear axle 300 from moving laterally.

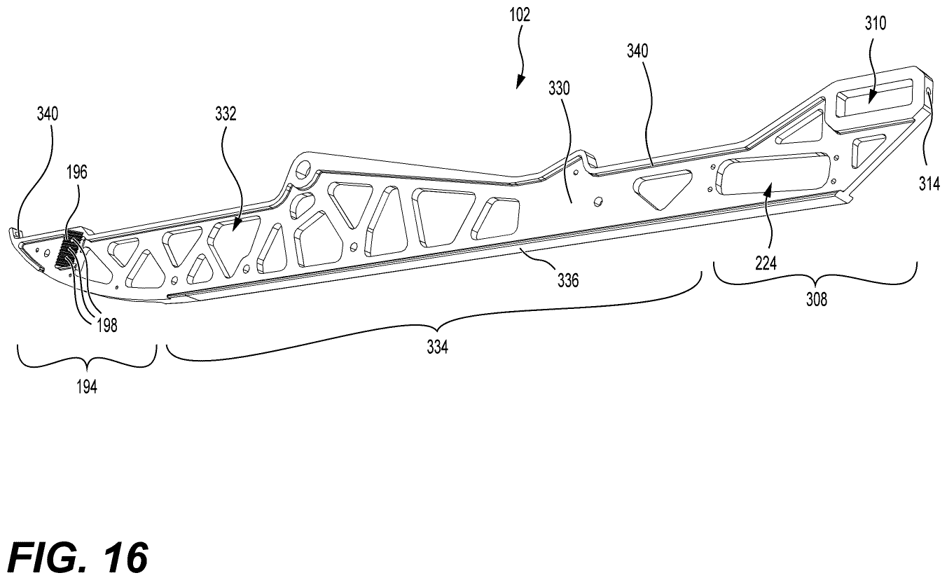

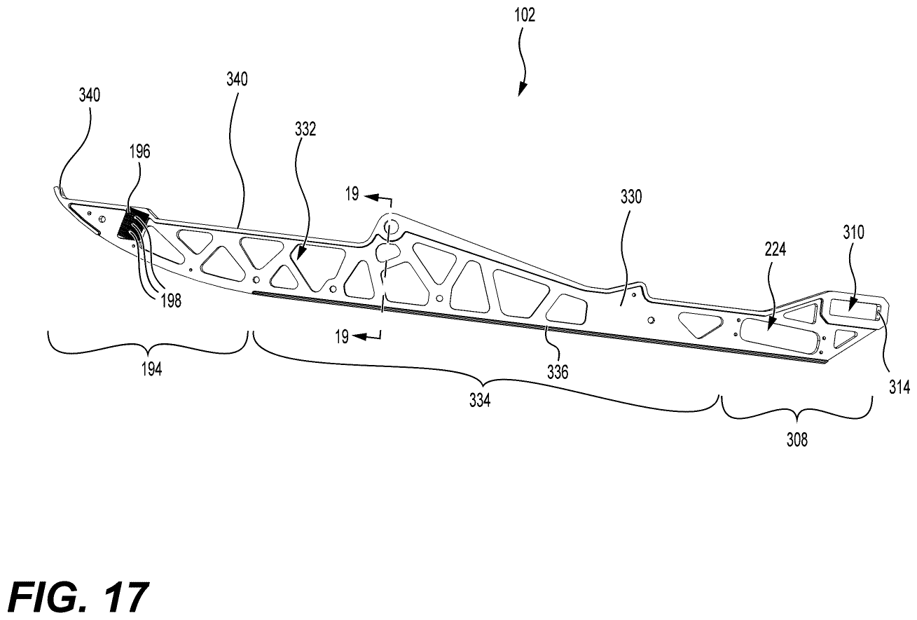

With reference to FIGS. 16 and 17, a rear left tensioner aperture 314 is defined in a rear end of the left slide rail 102. The rear left tensioner aperture 314 extends longitudinally from the rear end of the left slide rail 102 to the rear left tensioner slot 310. In the present embodiment, the rear left tensioner aperture 314 is threadless (i.e., the cylindrical wall defining the aperture 314 is free of screw threads). In the present embodiment, the rear left tensioner aperture 314 is laterally centered in the rear end of the left slide rail 102. In the present embodiment, the rear left tensioner aperture 314 is vertically centered in the rear left tensioner slot 310. The right slide rail 102 defines a corresponding rear right tensioner aperture 314 in a rear end thereof.

Returning to FIGS. 20 to 23, a left tensioner fastener 316 extends through the rear left tensioner aperture 314 and into the rear left tensioner slot 310 where it fastens via a threaded end of the fastener 316 to the left end of the rear axle 300. Similarly, a right tensioner fastener 316 extends through the rear right tensioner aperture 314 and into the rear right tensioner slot 310 where it fastens via a threaded end of the fastener 316 to the right end of the rear axle 300.

As can be seen in FIG. 1, the idler wheels 302 roll along an inside surface of the endless track 44. As such, tension in the endless track 44 cause the endless track 44 to push on the idler wheels 302. A forward component of the force applied by the endless track 44 on the idler wheels 302 pushes the entire rear idler wheel assembly 114. This causes the rear axle 300 to move forward on the heads of the tensioner fasteners 316 abut the rear ends of the slide rails 102.

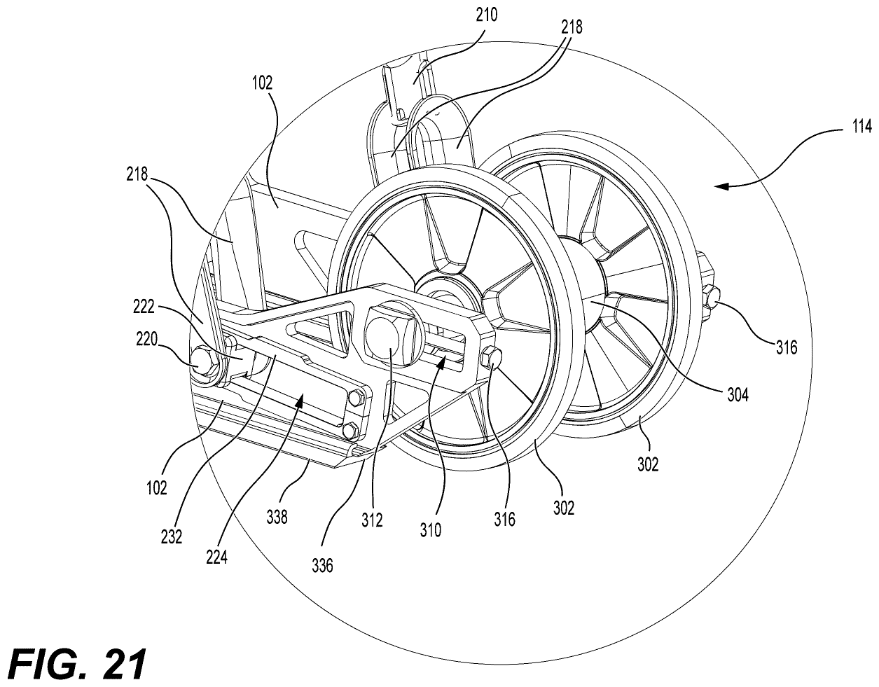

By rotating the left and right tensioner fasteners 316, the rear axle 300 translates in the tensioner slots 310 and the distance between the ends of the rear axle 300 and the rear ends of the slide rails 102 is adjusted, which also moves the rear idler wheels 302 forward or backward as the case may be. By moving the rear axle 300 and the rear idler wheels 302 forward, the tension in the endless track 44 is reduced. By moving the rear axle 300 and the rear idler wheels 302 rearward, the tension in the endless track 44 is increased. As such, there is more tension in the endless track 44 when the rear axle 300 and the rear idler wheels 302 are in the position shown in FIG. 20 then when rear axle 300 and the rear idler wheels 302 are in the position shown in FIG. 21.

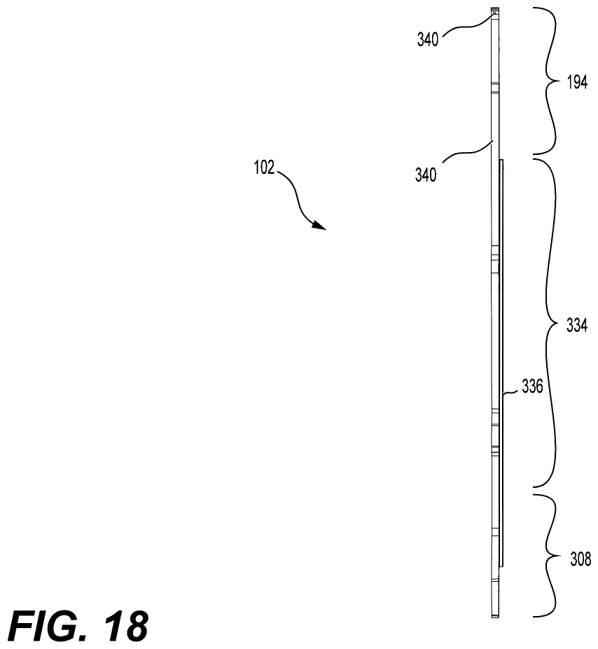

Turning now to FIGS. 16 to 19, additional features of the slide rails 102 will be described with respect to the left slide rail 102. The right slide rail 102 is a mirror image of the left slide rail 102.

The slide rail 102 has a vertical wall 330. The vertical wall 330 defines a plurality of wall apertures 332 to reduce the weight of the slide rail 102. In the present embodiment, a surface area of the plurality of wall apertures 332 is greater than a surface area of the vertical wall 330 (i.e., the solid portions of the vertical wall 330). It is contemplated that the vertical wall 330 could have more or less wall apertures 332 than illustrated. It is also contemplated that the wall apertures 332 could be omitted in some embodiments.

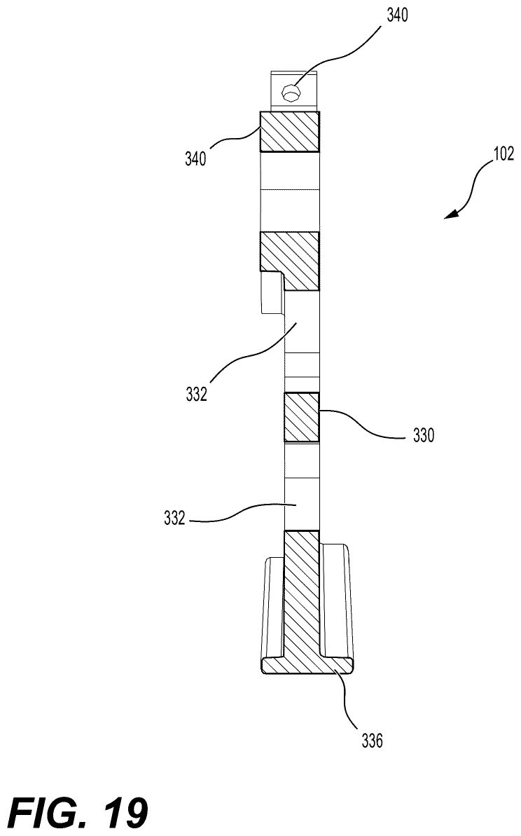

As previously mentioned, the front end portion 194 of the slide rail 102 is upturned. A bottom of a middle portion 334 and a bottom of the rear end portion 308 are flat. The middle and rear end portions 334, 308 have a bottom wall 336. The vertical wall 330 connects to a top of the bottom wall 336. As can be seen in FIGS. 16 and 19, the bottom wall 336 extends laterally outward from a left side of the vertical wall 330 and laterally outward from a right side of the vertical wall 330. As can be seen in FIG. 19, the vertical wall 330 and the bottom wall 336 form an inverted T-shape. As can also be seen in FIG. 19, the bottom wall 336 extends further to the right of the vertical wall 330 than to the left of the vertical wall 330. In the present embodiment, the bottom wall 336 extends along an entire length of the middle portion 334 and the rear end portion 308. It is contemplated that in some embodiments, the bottom wall 336 could extend along a majority of the length of the middle portion 334 and the rear end portion 308. It is contemplated that in some embodiments, the bottom wall 336 could be made of a plurality of longitudinally spaced apart bottom wall sections. With reference to FIGS. 2, 4, and 9, the bottom wall 336 is received in slots defined in a slider shoe 338 provided along a bottom of the slide rail 102. The front end portion 194 of the slide rail 102 defines an aperture 340 to receive a fastener 342 used to fasten the front of the slider shoe 338 to the front end portion 194 of the slide rail 102.

Returning to FIGS. 16 to 19, a top wall 340 is connected to a top of the vertical wall 330. In this embodiment, the top wall 340 is connected to the top of the vertical wall 330 along the front end portion 194, the middle portion 334 and the rear end portion 308. It is contemplated that the top wall 340 could extend along only one or two of the portions 194, 334, 308. It is contemplated that in some embodiments, the top wall 340 could be made of a plurality of longitudinally spaced apart top wall sections. The top wall 340 extends laterally outward from only the left side of the vertical wall 330. Alternatively, it is contemplated that the top wall 340 could extend laterally outward from only the right side of the vertical wall 330. As can be seen in FIGS. 9 and 19, the vertical wall 330 and the top wall 340 form an inverted L-shape. The top wall 340 reinforces the slide rail 102.

Modifications and improvements to the above-described embodiments of the present invention may become apparent to those skilled in the art. The foregoing description is intended to be exemplary rather than limiting. The scope of the present technology is therefore intended to be limited solely by the appended claims.

What is claimed is:

1. A slide rail for a snowmobile rear suspension comprising:
an upturned front end portion;
a middle portion rearward of the upturned front end portion, a bottom of the middle portion being flat;
a rear end portion rearward of the middle portion, a bottom of the rear end portion being flat,
the middle portion and the rear end portion comprising a bottom wall and a vertical wall connected to a top of the bottom wall, the bottom wall extending laterally outward from a left side of the vertical wall and laterally outward of a right side of the vertical wall to form an inverted T-shape; and
a top wall connected to a top of the vertical wall, the top wall extending laterally from at least one of the left and right sides of the vertical wall.

2. The slide rail of claim 1, wherein the bottom wall extends along a majority of a length of the middle portion and the rear end portion.

3. The slide rail of claim 2, wherein the bottom wall extends along an entire length of the middle portion and the rear end portion.

4. The slide rail of claim 1, wherein the top wall is connected to the vertical wall along the front end portion, the middle portion, and the rear end portion.

5. The slide rail of claim 1, wherein the vertical wall defines a plurality of wall apertures.

6. The slide rail of claim 5, wherein a surface area of the plurality of wall apertures is greater than a surface area of the vertical wall.

7. The slide rail of claim 1, wherein:
the front end portion defines an aperture for receiving a fastener for fastening a slider shoe to the slide rail; and
the bottom wall is configured from being received in slots defined in the slider shoe.

8. The slide rail of claim 1, wherein the top wall extends laterally outward from only one of the left and right sides of the vertical wall to form an inverted L-shape.

9. The slide rail of claim 8, wherein the top wall is connected to the vertical wall along the front end portion, the middle portion, and the rear end portion.

10. A snowmobile rear suspension comprising:
a left slide rail;
a right slide rail;
a front suspension arm assembly pivotally connected to the left slide rail and the right slide rail;
a rear suspension arm assembly pivotally connected to the left slide rail and the right slide rail; and
a shock absorber pivotally connected to one of the front and rear suspension arm assemblies and pivotally connected to the left and right slide rails,
each of the left slide rail and the right slide rail comprising:
an upturned front end portion;
a middle portion rearward of the upturned front end portion, a bottom of the middle portion being flat;
a rear end portion rearward of the middle portion, a bottom of the rear end portion being flat,
the middle portion and the rear end portion comprising a bottom wall and a vertical wall connected to a top of the bottom wall, the bottom wall extending laterally outward from a left side of the vertical wall and laterally outward of a right side of the vertical wall to form an inverted T-shape; and
a top wall connected to a top of the vertical wall, the top wall extending laterally outward from at least one of the left and right sides of the vertical wall.

11. The snowmobile rear suspension of claim 10, wherein, for each of the left slide and the right slide rail, the bottom wall extends along a majority of a length of the middle portion and the rear end portion.

12. The snowmobile rear suspension of claim 11, wherein, for each of the left slide and the right slide rail, the bottom wall extends along an entire length of the middle portion and the rear end portion.

13. The snowmobile rear suspension of claim 10, wherein, for each of the left slide and the right slide rail, the top wall is connected to the vertical wall along the front end portion, the middle portion, and the rear end portion.

14. The snowmobile rear suspension of claim 10, wherein, for each of the left slide and the right slide rail, the vertical wall defines a plurality of wall apertures.

15. The snowmobile rear suspension of claim 14, wherein, for each of the left slide and the right slide rail, a surface area of the plurality of wall apertures is greater than a surface area of the vertical wall.

16. The snowmobile rear suspension of claim 10, wherein, for each of the left slide and the right slide rail:
the front end portion defines an aperture for receiving a fastener for fastening a slider shoe to the slide rail; and
the bottom wall is configured from being received in slots defined in the slider shoe.

17. The snowmobile rear suspension of claim 10, wherein:
for the left slide rail, the top wall extends laterally outward from only the left side of the vertical wall to form an inverted L-shape; and
for the right slide rail, the top wall extends laterally outward from only the right side of the vertical wall to form an inverted L-shape.

18. The snowmobile rear suspension of claim 17, wherein, for each of the left slide and the right slide rail, the top wall is connected to the vertical wall along the front end portion, the middle portion, and the rear end portion.

19. A snowmobile comprising:
a frame, the frame having a tunnel;
at least one ski operatively connected to the frame;
the snowmobile rear suspension of claim 10 operatively connected to the tunnel;
an endless track provided around the snowmobile rear suspension; and
a motor operatively connected to the endless track for driving the endless track.
